(19) United States
(12) Patent Application Publication
(10) Pub. No.: US 2024/0296411 A1
(43) Pub. Date: Sep. 5, 2024

(54) ORDER DISPLAY AND ACCURACY SYSTEM

(71) Applicant: Cargill, Incorporated, Wayzata, MN (US)

(72) Inventors: Aron Mckenzie Braggans, St Louis Park, MN (US); Nicholas Michael Degnan, Redondo Beach, CA (US); Montana Mae Gordon, St Louis, MO (US); Jonathan Mark Griebel, Maple Grove, MN (US); Kyle Stephen Keller, Saint Paul, MN (US); Justin K. Kuto, Bloomington, MN (US)

(21) Appl. No.: 18/591,317

(22) Filed: Feb. 29, 2024

Related U.S. Application Data
(60) Provisional application No. 63/488,288, filed on Mar. 3, 2023.

(51) Int. Cl. G06Q 10/0639; G06Q 50/12

(52) U.S. Cl. CPC G06Q 10/06398; G06Q 50/12

(57) ABSTRACT

Aspects of this technical solution can include receiving an order for food, the order including order data, identifying ingredient data and item data from the order data, displaying at least one of a portion of the ingredient data or a portion of the item data on one or more stations configured for preparing the order, where the portion of the ingredient data and the portion of the item data displayed on each of the one or more stations is based on a task to be performed at a respective one of the one or more stations, monitoring the task at each the one or more stations as the task is performed for compliance with the portion of the ingredient data and the portion of the order data displayed at the respective one of the one or more stations, and executing an action based on the monitoring.

### CROSS-REFERENCE TO RELATED APPLICATIONS

This application claims the benefit of U.S. Provisional Application No. 63/488,288, filed Mar. 3, 2023, which is incorporated by reference herein in its entirety.

### TECHNICAL FIELD

The present disclosure relates generally to machine learning systems, including but not limited to an order display and accuracy system.

### INTRODUCTION

Service industries face increasing demands to provide products and services with higher accuracy to satisfy consumer needs and to minimize loss through wasted resources. In particular, food service industries face increasing pressure to deliver an increasing number of products having increasingly complex preparation. In parallel, businesses and customers demand delivery of these products within less time and at higher accuracy. However, manual monitoring of these processes cannot effectively scale with both increased product volumes and increased product complexity.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

This technical solution is directed at least to monitor the preparation of food items at an ingredient-level, and provide feedback at particular food preparation stations and administrative stations via particular user interfaces. The technical solution includes identifying correlations between ingredients of food, food items having various ingredients, and food orders having various food items, to identify and monitor whether assembly of food items conforms to a particular recipe for that food item. The technical solutions can include monitoring and assessing items in an order as the order is assembled to visually indicate an aggregation and completion of the order. The technical solution can include a learning or training mode in which a machine learning model correlates ingredients, items, and orders based on monitoring of food preparation via one or more food preparation stations and food storage locations in one more food preparation environments. This technical solution can provide at least the technical improvements of consuming and mapping information about an order to the station where the item is being prepared for that particular order, can display presentations about food preparation customized to a particular food preparation station, and can provide an administrative user interface to provide live or real-time monitoring and modification of an order or an item of an order. Thus, a technical solution for identification and verification of accuracy of food assembly and order completion via machine learning is provided.

At least one aspect is directed to a method. The method can include receiving an order for food, where the order can include order data. The method can include identifying ingredient data and item data from the order data. The method can include displaying at least one of a portion of the ingredient data or a portion of the item data on one or more stations configured for preparing the order, where the portion of the ingredient data and the portion of the item data displayed on each of the one or more stations are based on a task to be performed at a respective one of the one or more stations. The method can include monitoring the task at each of the one or more stations as the task is performed for compliance with the portion of the ingredient data and the portion of the order data displayed at the respective one of the one or more stations. The method can include executing an action based on the monitoring.

At least one aspect is directed to a system. The system can include a memory having computer-readable instruction stored thereon and one or more processors that execute the computer-readable instructions. The one or more processors can receive an order for food, where the order can include order data. The one or more processors can identify ingredient data and item data from the order data. The one or more processors can display at least one of a portion of the ingredient data or a portion of the item data on one or more stations configured for preparing the order, where the portion of the ingredient data and the portion of the item data displayed on each of the one or more stations are based on a task to be performed at a respective one of the one or more stations. The one or more processors can monitor the task at each of the one or more stations as the task is performed for compliance with the portion of the ingredient data and the portion of the order data displayed at the respective one of the one or more stations. The one or more processors can execute an action based on the monitoring.

At least one aspect is directed to a non-transitory computer readable medium including computer-readable instructions that when executed by one or more processors cause the one or more processors to receive an order for preparing food, the order including order data. The one or more processors can identify ingredient data and item data from the order data. The one or more processors can display at least one of a portion of the ingredient data or a portion of the item data on one or more stations configured for preparing the order, where the portion of the ingredient data and the portion of the item data displayed on each of the one or more stations is based on a task to be performed at a respective one of the one or more stations. The one or more processors can monitor the task at each of the one or more stations as the task is performed for compliance with the portion of the ingredient data and the portion of the item data displayed at the respective one of the one or more stations. The one or more processors can execute an action based on the monitoring.

At least one aspect is directed to a method of verification of assembly of food or assembly of order. The method can include linking, based on a type of an expected item in an order, the expected item to a first field of view in a physical space corresponding to a location of assembly of the expected item or the order. The method can include detecting, by a first machine learning model receiving input corresponding to the first field of view, a first geometric feature in the first field of view, the first machine learning model trained with input that can include a plurality of ingredients or plurality of items. The ingredients can include an expected ingredient linked with the expected item. The method can include causing, in response to a determination that the first geometric feature diverges from a second geometric feature corresponding to the expected ingredient, a user interface to present an indication of divergence.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE FIGURES

These and other aspects and features of the some embodiments are depicted by way of example in the figures discussed herein. Some embodiments can be directed to, but are not limited to, examples depicted in the figures discussed herein.

FIG. 1 depicts an example system, in accordance with some embodiments.

FIG. 2 depicts an example order preparation environment implemented by the system of FIG. 1, in accordance with some embodiments.

FIG. 3 depicts an example ingredient assessment state implemented by the system of FIG. 1, in accordance with some embodiments.

FIG. 4A depicts an example item mismatch assessment state implemented by the system of FIG. 1, in accordance with some embodiments.

FIG. 4B depicts an example item loss assessment state implemented by the system of FIG. 1, in accordance with some embodiments.

FIG. 5 depicts an example order placement assessment state implemented by the system of FIG. 1, in accordance with some embodiments.

FIG. 6 depicts an example preparation training state implemented by the system of FIG. 1, in accordance with some embodiments.

FIG. 7 depicts an example ingredient storage training state implemented by the system of FIG. 1, in accordance with some embodiments.

FIG. 8A depicts an example ingredient retrieval state implemented by the system of FIG. 1, in accordance with some embodiments.

FIG. 8B depicts an example ingredient retrieval state implemented by the system of FIG. 1, in accordance with some embodiments.

FIG. 9 depicts an example hub system implemented by the system of FIG. 1, in accordance with some embodiments.

FIG. 10 depicts an example hub controller process implemented by the system of FIG. 1, in accordance with some embodiments.

FIG. 11 depicts an example ingredient system process implemented by the system of FIG. 1, in accordance with some embodiments.

FIG. 12 depicts an example display system process implemented by the system of FIG. 1, in accordance with some embodiments.

FIG. 13 depicts an example identification system implemented by the system of FIG. 1, in accordance with some embodiments.

FIG. 14 depicts an example reporting system process implemented by the system of FIG. 1, in accordance with some embodiments.

FIG. 15 depicts an example confirmation system process implemented by the system of FIG. 1, in accordance with some embodiments.

FIG. 16 depicts an example method of identification and verification of accuracy of food assembly implemented by the system of FIG. 1, in accordance with some embodiments.

FIG. 17 depicts an example method of identification and verification of accuracy of food assembly via machine learning implemented by the system of FIG. 1, in accordance with some embodiments.

FIG. 18 depicts an example of order monitoring and verification by the system of FIG. 1, in accordance with some embodiments.

FIG. 19 depicts an example order assembly system, in accordance with some embodiments.

FIGS. 20A-20E provide example user interfaces of the order assembly system of FIG. 19, in accordance with some embodiments.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

The food service industry is facing increasing pressure from consumers to provide high-quality products and services with exacting accuracy, and ever-decreasing price points. In parallel, consumers are increasingly demanding more complex and sophisticated products and services, including at least food products with increasingly complex ingredient compositions and increasingly diverse ingredients. Thus, food service providers must understand an increasingly complex tapestry of menu items, an increasingly diverse and potentially exotic array of ingredients used in those food items, and increasing customization of those food items into a wide array of customized food items, or orders including a plurality of food items. The level of complexity of food preparation and food service thus can increase dramatically, putting significant cognitive load on food service professionals. The increased complexity of food preparation environments caused by these consumer demands can significantly reduce or eliminate the ability of food service providers to operate successfully at commercial scale.

Food service operations can benefit greatly from reliable identification of ingredients, food items, and orders, and live feedback during food preparation to ensure satisfaction of recipes corresponding to particular food items and satisfaction of orders corresponding to particular customer preferences. The cognitive load for food service professional can be decreased significantly with systems to identify ingredients that can otherwise be unknown to individual food service professionals, and recipes for food items or orders with which food service professionals can require additional training. Thus, a system including the systems discussed herein, that can, among other capabilities, provide live feedback to food preparation professionals in an integrated food preparation environment, can significantly increase capacity of food service delivery systems, by reducing the training required of food service professionals, and increasing the effectiveness and efficiency of food service professionals having particular training with particular food preparation environments and the products and services thereof.

Thus, aspects of this technical solution are directed, but not limited, to a system with cameras, displays, and machine learning (ML) models, to recognize and notify one or more users of states of one or more physical objects at one or more designated physical locations in an environment. The states can correspond to indications for particular ingredients of food, particular food items having collections of ingredients, and particular collections of food items corresponding to orders for food. The system can assist in identifying ingredients associated with one or more food items and the orders for which those food items are contained, and can present user interface indications associated with particular locations, stations, or workflows of a food preparation environment. This technical solution can include one or more machine learning models trained to identify particular ingredients, relationships between particular ingredients and particular food items, and particular food items and food orders. The technical solution can determine, based on one or more sensors, locations of ingredients and can correlate retrieval of ingredients from particular locations in a food preparation environment with particular food items or orders. At least some of the machine learning models can be configured for continuous training. For example, in some embodiments, the output from the machine learning model can be input back into the machine learning model for continuous training and increasing accuracy. As an example, preset zones in a field of view of a camera can be defined and then orders assigned to those zones can be monitored. For every item that gets put into a particular preset zone that's associated with any order, data can be collected. With little additional data being provided directly other than sensor data from the camera of items passing through the field of view, the machine learning model can begin to apply deductive reasoning based on what is expected and recognize types of items and variants of types of items, and so on until the machine learning model's prediction of what has been put into a zone matches the actual order to a very high level accuracy (e.g., greater than a predetermined threshold). At that time, the machine learning model can transition from learning to providing order composition (accuracy) feedback.

This technical solution can provide for assessing items of an order in a field of view (e.g., in a pass-through area) using sensors (e.g., cameras) and dynamically assigning zones on a two dimensional plane (e.g., surface top with lines drawn on it, light projection on a surface top, video screen, etc.) to visually indicate an aggregation and ultimately the completion of an order of those items. Thus, the technical solution allows defining dynamically expanding and contracting zones where order is being assembled. In other words, a location can be defined into one or more dynamic zones, each of which can be tracked and monitored for facilitating order assembly and completion with accuracy.

This technical solution can provide one or more user interface presentations corresponding to particular physical locations or particular food preparation processes. For example, a system can correlate a particular ingredient with a particular food preparation station, can identify a location of storage of the food item, and can provide an indication that an ingredient placed at the food preparation station corresponds to the identified ingredient. The technical solution can provide a presentation to aggregate state at multiple food preparation stations, to provide ingredient-level awareness and feedback from an arbitrary number of food preparation stations at an arbitrary number and type of local or remote physical locations.

Thus, this technical solution can provide at least the technical improvement or live or real-time monitoring and feedback of food preparation processes at high-scale and without geographic limit, beyond the capability of manual monitoring and feedback of food preparation processes. For example, this technical solution can provide at least the technical improvement of high-scale identification of composition of food items and orders based on an arbitrary number and type of ingredients at or within a physical environment. The technical solution can include a technical improvement of visual recognition of ingredients, food items, and orders at a scale far exceeding human memory or reaction time. For example, the technical solution can be trained to recognize hundreds, thousands, millions, or any arbitrary number of distinct ingredients, food items, and orders. The technical solution can include a technical improvement of high-scale feedback during preparation and assembly of ingredients, food items, and orders at one or more food preparation stations of one or more food preparation environments. For example, this technical solution can provide individualized live feedback to an arbitrary number of food preparation professional at an arbitrary number of food preparation stations or environments, far exceeding capacity of feedback, monitoring, or supervision possible manually. Thus, this technical solution can provide at least the technical improvements discussed herein, but is not limited thereto.

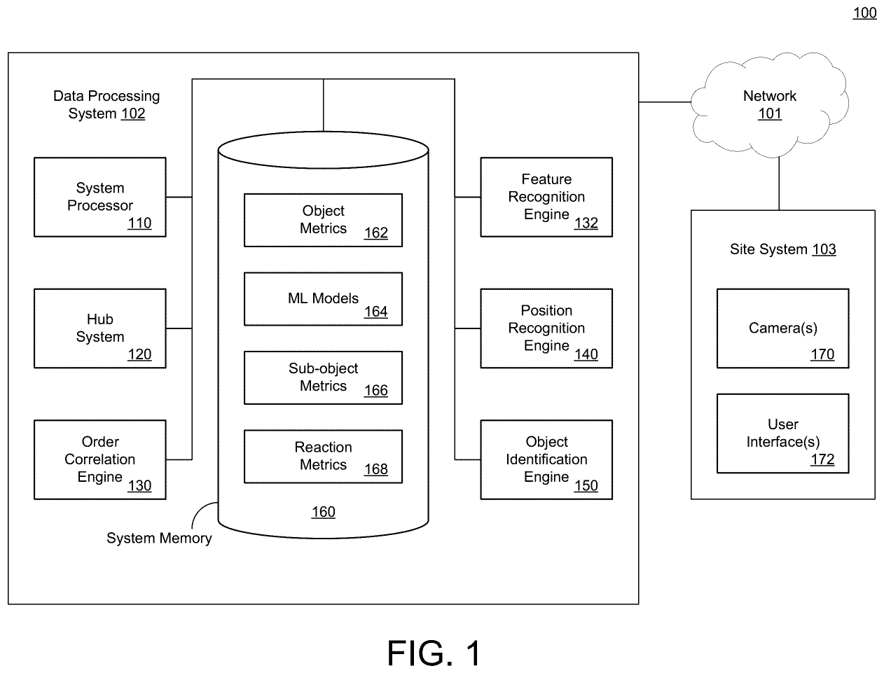

FIG. 1 depicts an example system, in accordance with some embodiments. As illustrated by way of example in FIG. 1, an example system 100 can include at least a network 101, a data processing system 102, and a site system 103. Although the present disclosure is discussed in the context of food items, the present disclosure can be applicable in other applications such as non-food items or non-food industries.

The network 101 can include any type or form of network. The geographical scope of the network 101 can vary widely and the network 101 can include a body area network (BAN), a personal area network (PAN), a local-area network (LAN), e.g. Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The ‘TCP/IP Internet protocol suite can include application layer, transport layer, Internet layer (including, e.g., IPv6), or the link layer. The network 101 can include a type of a broadcast network, a telecommunications network, a data communication network, or a computer network.

The data processing system 102 can include a physical computer system operatively coupled or that can be coupled with one or more components of the system 100, either directly or directly through an intermediate computing device or system. The data processing system 102 can include a virtual computing system, an operating system, and a communication bus to effect communication and processing. The data processing system 102 can be implemented as or including a variety of computing devices such as computers (e.g., desktop, laptop, servers, data centers, etc.), tablets, personal digital assistants, mobile devices, other handheld or portable devices, or any other computing unit suitable for executing instructions in accordance with this technical solution. The data processing system 102 can include a system processor 110, a hub system 120, an order correlation engine 130, a feature recognition engine 132, a position recognition engine 140, an object identification engine 150, and a system memory 160.

The system processor 110 can execute one or more instructions associated with the system 100, including but not limited to instructions associated with one or more of the hub system 120, the order correlation engine 130, the feature recognition engine 132, the position recognition engine 140, the object identification engine 150, and the system memory 160. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), Application Specific Integrated Circuit (“ASIC”), Field Programmable Gate Array (“FPGA”), or any other type of processing unit. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the system 100 generally can include one or more communication bus controller to effect communication between the system processor 110 and the other elements of the system 100.

The hub system 120 can coordinate food preparation monitoring, food preparation feedback, and food preparation learning operations for one or more physical locations. For example, the hub system 120 can be linked with one or more physical location having one or more food preparation stations or administrative stations. For example, the hub system 120 can be linked with a first restaurant having a first plurality of food preparation stations and a first localized administrative station. For example, the hub system 120 can also or alternatively be linked with a second restaurant having a second plurality of food preparation stations and a second localized administrative station. For example, the hub system 120 can also or alternatively be linked with an administrative site including one or more administrative stations. The hub system 120 can obtain and exchange data from one or more restaurants, food preparation stations, food storage locations, and administrative stations, to learn correlations between ingredients, food items, and orders at high scale and independent of any geographic constraints.

The order correlation engine 130 can execute one or more models to link one or more ingredients with one or more items, and one or more items with one or more orders. For example, the order correlation engine 130 can identify particular ingredients associated with particular items based on predetermined recipe data. The order correlation engine 130 can identify particular orders based on particular items associated with predetermined order data. The order data can include historical orders or current ordered obtained at the order correlation engine 130 via the site system 103 or the system memory 160. Order data can include identification or definition of one or more ingredients, food items, order collections, or any combination thereof. Order data can include identification or definition of one or more modifications to one or more predetermined ingredients, food items, order collections, or any combination thereof. For example, an order can identify a food item of a “super burrito” and a second food item of “tortilla chips,” or can identify a “super burrito” with a modification to “substitute black beans” and a second food item of “tortilla chips.” Order data can correspond at least partially in one or more of structure and operation to an order as discussed herein.

The feature recognition engine 132 can identify one or more characteristics of one or more objects detected at the system site system 103. For example, the feature recognition engine 132 can identify one or more edges, shapes, colors, patterns, textures, or any combination thereof, of an object by a visual or near-visual detection of the object. For example, visual detection can include detection by camera or video within visible spectra of light. For example, near-visual detection can include detection by camera or video within infrared or ultraviolet spectra of light. The feature recognition engine 132 can generate or identify, for example, a metric corresponding to the edges, shapes, colors, patterns, textures, or any combination thereof, of the object.

The position recognition engine 140 can determine a location corresponding to one or more ingredients, objects, items, or any combination thereof. For example, the position recognition engine 140 can identify a particular field of view corresponding to a particular food preparation station, and can determine presence of an ingredient at that location by the feature recognition engine 132 or an object identification engine 150. Thus, the position recognition engine 140 can determine whether presence of an ingredient at a particular physical location corresponding, for example, to a food preparation station. For example, the position recognition engine 140 can identify a particular field of view corresponding to a particular food preparation station, and can determine whether an ingredient, item, or order is present at the particular field of view. Thus, the position recognition engine 140 can detect whether an ingredient, item, or order is present at a predetermined food preparation station at a particular point in a food preparation or delivery process. For example, a food preparation station can correspond to any physical location for preparation or placement of an ingredient, item, or order, or any combination thereof.

The object identification engine 150 can correlate the metric from the feature recognition engine with an ingredient, object, or order to identify the ingredient object, or order. For example, the object identification engine 150 can include a trained machine learning model to receive the metric as input and generate as output an identifier corresponding to one or more of an ingredient, item, or order corresponding to the metric. The object identification engine 150 can operate one or more machine learning models in a training mode to identify one or more metrics corresponding to one or more features of one or more ingredients, objects, or orders. For example, the object identification engine 150 can train a first machine learning model to output indicators of particular ingredients based on input camera or video data corresponding to one or more food preparation stations or food storage stations. For example, the object identification engine 150 can train a second machine learning model to output indicators of particular food items based on input camera or video data corresponding to one or more food preparation stations or food storage stations. For example, the object identification engine 150 can train a third machine learning model to output indicators of particular orders based on input camera or video data corresponding to one or more food preparation stations or food storage stations.

The system memory 160 can store data associated with the system 100. The system memory 160 can include one or more hardware memory devices to store binary data, digital data, or the like. The system memory 160 can include one or more electrical components, electronic components, programmable electronic components, reprogrammable electronic components, integrated circuits, semiconductor devices, flip flops, arithmetic units, or the like. The system memory 160 can include at least one of a non-volatile memory device, a solid-state memory device, a flash memory device, or a NAND memory device. The system memory 160 can include one or more addressable memory regions disposed on one or more physical memory arrays. A physical memory array can include a NAND gate array disposed on, for example, at least one of a particular semiconductor device, integrated circuit device, and printed circuit board device. The system memory 160 can include an object metrics 162, ML models 164, sub-object metrics 166, and reaction metrics 168.

The object metrics 162 can include various metrics generated by the order correlation engine 130. For example, the object metrics 162 can correspond to characteristics of food items or orders. The object metrics 162 can correspond to characteristics of food items or orders .at various states of incomplete or complete preparation. For example, the feature recognition engine can store object metrics 162 for one or more of a partially assembled food item, a partially assembled food order, a fully assembled food item, and a fully assembled food order. The ML models 164 can include one or more models generated or trained according to one or more of the order correlation engine 130, the feature recognition engine 132, the position recognition engine 140, and the object identification engine 150.

The sub-object metrics 166 can include various metrics generated by the feature recognition engine 132, the position recognition engine 140, and the object identification engine 150. For example, the sub-object metrics 166 can correspond to characteristics of ingredients. The object metrics 162 can correspond to characteristics of ingredients at various states of incomplete or complete preparation. For example, the feature recognition engine can store object metrics 162 for one or more of a partially prepared ingredient, and a fully prepared ingredient. The reaction metrics 168 can include one or more outputs of one or more systems of the hub system 120. For example, the reaction metrics 168 can include metrics for errors detected with respect to one or more ingredients, items, orders or any combination thereof. For example, the reaction metrics 168 can include metrics for completions detected with respect to one or more ingredients, items, orders or any combination thereof. For example, the reaction metrics 168 can include metrics for modifications detected with respect to one or more ingredients, items, orders or any combination thereof.

The site system 103 can include one or more devices located at a site. For example, a site can correspond to a physical space associated with one or more ingredients, items, or orders, and can correspond to a restaurant having one or more food preparation stations and food storage stations. The system 100 can include one or more site systems 103 corresponding to one or more restaurants. The site system 103 can include a camera(s) 170, and a user interface(s) 172. The camera(s) 170 can include one or more image capture or video capture devices to provide video assistance to identification or assembly, or any combination thereof, as discussed herein. For example, a site can include one or more cameras with corresponding fields of view oriented toward particular portions of the site or encompassing an entire site. The camera(s) 170 can correspond to any camera as discussed herein. The user interface(s) 172 can include one or more sound-emitting devices, display devices, light-emitting devices, or any combination thereof. For example, the user interfaces 172 can include one or more electronic displays. An electronic display can include, for example, a liquid crystal display (LCD), a light-emitting diode (LED) display, an organic light-emitting diode (OLED) display, or the like. The display devices can receive, for example, capacitive or resistive touch input. The user interfaces 172 can correspond to any display or user interface as discussed herein.

Although the various components of FIG. 1 has been described as communicating via the network 101, in some embodiments, one or more of the components can be edge devices or other type of devices configured to operate in an “offline mode” if the network 101 becomes unavailable and configured to operate locally.

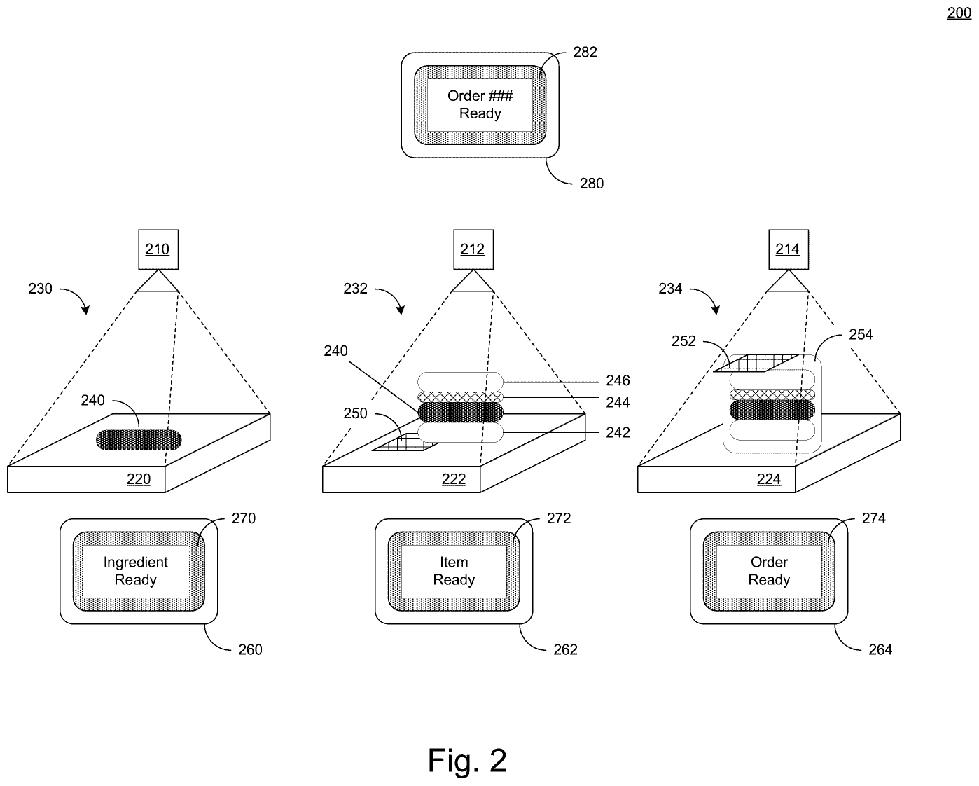

FIG. 2 depicts an example order preparation environment, in accordance with some embodiments. As illustrated by way of example in FIG. 2, an example order preparation environment 200 can include at least preparation cameras 210, 212 and 214, an ingredient preparation station 220, an item preparation station 222, an order preparation station 224, physical environments 230, 232 and 234, an ingredient 240, secondary ingredients 242, 244 and 246, an order indicator 250, an applied order indicator 252, an order collection 254, an ingredient user interface 260, an item user interface 262, an order user interface 264, an ingredient state indication 270, an item state indication 272, an order state indication 274, a supervisor user interface 280, and an order state indication 282. For example, the order preparation environment 200 can correspond to a kitchen of a restaurant. For example, the physical environments 230, 232 and 234 can respectively be at least partially within respective fields of view of the preparation cameras 210, 212 and 214. The order preparation environment 200 is not limited to the number or type of stations as discussed and illustrated herein by way of example.

The preparation cameras 210, 212 and 214 can be oriented in the order preparation environment 200 with respect to one or more food preparation stations. For example, one or more of the preparation cameras 210, 212 and 214 can be mounted above or over the station to provide an unobstructed view of one or more of a working surface of the station and a food storage or staging area corresponding to the food preparation station. For example, in some embodiments, one or more of the cameras 210, 212, and 214 can be pointed down towards the food preparation stations. In some embodiments, one or more of the cameras 210, 212, and 214 can be mounted to point straight or substantially straight at the food preparation stations. The configuration of the preparation cameras 210, 212 and 214 is not limited to the configuration or placement as illustrated herein by way of example, and can include an arbitrary number of cameras each associated with an arbitrary number of physical locations based on or customized to a specific order preparation environment or a specific type or group of order preparation environment.

The ingredient preparation station 220 can correspond to a physical location where one or more ingredients are prepared. For example, the ingredient preparation station 220 can correspond to a grill for preparation of a patty of a burger. The ingredient preparation station 220 can be associated with one or more ingredients, by one or more metrics by the feature recognition engine 132 or the position recognition engine 140. The item preparation station 222 can correspond to a physical location where one or more items are prepared or assembled. For example, the item preparation station 222 can correspond to a table for assembly of a burger. The item preparation station 222 can be associated with one or more items, by one or more metrics by the feature recognition engine 132 or the object identification engine 150. The item preparation station 222 can correspond to an ingredient preparation station 220 for particular food preparation operations. For example, a grill can correspond to an ingredient preparation station 220 for preparation of a patty, and can correspond to an item preparation station 222 during assembly of a cheese slice on the completed burger patty. The order preparation station 224 can correspond to a physical location where one or more orders are prepared. For example, the order preparation station 224 can correspond to a tabletop surface or portion of a tabletop surface designated for assembly of an order including a burrito, tortilla chips, and a soda. The order preparation station 224 can be associated with one or more items, by one or more metrics by the feature recognition engine 132, the position recognition engine 140 or the object identification engine 150.

The physical environments 230, 232 and 234 can correspond to portions of the order preparation environment 200 respectively corresponding to the ingredient preparation station 220, the item preparation station 222, or the order preparation station 224. The physical environments 230, 232 and 234 are not limited to the number or configuration of physical environment illustrated herein by way of example. Each of the physical environments 230, 232 and 234 can correspond to food preparation stations including corresponding fields of views.

The ingredient 240 can correspond to a portion of a food item. For example, the ingredient 240 can include a patty corresponding to a portion of a burger. The camera 210 can monitor the ingredient 240 live to determine a completion of preparation of the ingredient 240 or execution of an action related to preparation of the ingredient 240. For example, the camera 210 can detect when the patty is cooked sufficiently to be added to a burger or when the patty is ready to be flipped.

The secondary ingredients 242, 244 and 246 can correspond to portions of a food item distinct from the ingredient 240. For example, the secondary ingredients 242, 244 and 246 can be prepared at one or more ingredient preparation stations distinct from the ingredient preparation station 220, or can be obtained without separate preparation for direct assembly with the food item. For example, the secondary ingredients 242, 244 and 246 can respectively correspond to a bottom burger bun, a cheese slice, and a top burger bun.

The order indicator 250 can include a physical indicator to link an item with an order. For example, the order indicator 250 can correspond to a printed identifier of an order corresponding to the item. For example, the printed identifier can correspond to a QR code, bar code, or machine-readable visual pattern. The camera 212 can detect the presence of the order indicator 250 as a component of the order, and can indicate completion of the food item in response to detecting the order indicator 250 and detecting assembly of the food item according to a recipe for the food item according to an order. The applied order indicator 252 can correspond to the order indicator 250 and can be physically linked with an order including the food item assembled at item preparation station 222. The order collection 254 can correspond to a container for the order. For example, the order collection 254 can include a bag or tray corresponding to the order. The camera 214 can detect placement of one or more food items corresponding to the order based on one or more features of the food items, one or more order indicators 250 for one or more of the food items, or any combination thereof. For example, the applied order indicator 252 can be attached to the order collection 254 for the order, with other food items prepared at ingredient preparation stations or item preparation stations distinct from the stations 220 and 222. The position of the order indicator 250 and the applied order indicator 252 are not limited to the positions or connections illustrated herein by way of example, and can be located at any position within a field of view of a camera of an order preparation environment as discussed herein, including the order preparation environment 200. A food preparation environment can be used interchangeably with or as a subset of an order preparation environment as discussed herein.

The ingredient user interface 260 can include at least a display linked with the ingredient preparation station 220 and the physical environment 230. For example, the ingredient user interface 260 can generate one or more indications corresponding at least to presence, state, completion, error, or any combination thereof, of the ingredient 240. The item user interface 262 can include at least a display linked with the item preparation station 222 and the physical environment 232. For example, the item user interface 262 can generate one or more indications corresponding at least to presence, state, completion, error, or any combination thereof, of a food item assembled or under assembly. The order user interface 264 can include at least a display linked with the order preparation station 224 and the physical environments 234. For example, the item user interface 262 can generate one or more indications corresponding at least to presence, state, completion, error, or any combination thereof, of a food item assembled or under assembly. The user interfaces 260, 262 and 264 are not limited to distinct displays or devices, or the examples illustrated herein, can correspond to one or more displays or portions or displays.

The ingredient state indication 270 can include a presentation at the user interface 260 corresponding to the ingredient 240. For example, the ingredient state indication 270 can include one or more of a visual indication, an audio indication, or any combination thereof, and is not limited thereto. For example, the ingredient state indication 270 can present one or more indications corresponding at least to presence, state, completion, error, or any combination thereof, of the ingredient 240 prepared or under preparation. The item state indication 272 can include a presentation at the user interface 262 corresponding to a food item including one or more of the ingredients 240, 242, 244 and 264. For example, the item state indication 272 can include one or more of a visual indication, an audio indication, or any combination thereof, and is not limited thereto. For example, the item state indication 272 can present one or more indications corresponding at least to presence, state, completion, error, or any combination thereof, of the item at the physical location 222 prepared or under preparation. The order state indication 274 can include a presentation at the user interface 264 corresponding to an order including the item prepared at the physical location 222. For example, the order state indication 274 can include one or more of a visual indication, an audio indication, or any combination thereof, and is not limited thereto. For example, the order state indication 274 can present one or more indications corresponding at least to presence, state, completion, error, or any combination thereof, of the order collection 254 prepared or under preparation.

The supervisor user interface 280 can include at least a display linked with one or more of the cameras 210, 212 and 214 and the preparation stations 220, 222 and 224. For example, the supervisor user interface 280 can generate one or more indications corresponding at least to presence, state, completion, error, or any combination thereof, of an ingredient, item, or order assembled or under assembly. The supervisor user interface 280 is not limited to distinct displays or devices, or the examples illustrated herein, can correspond to one or more displays or portions or displays at any location at or remote from the order preparation environment 200.

The order state indication 282 can include a presentation at the user interface 280 corresponding to one or more of the state indications 270, 272 and 274. For example, the order state indication 282 can include one or more of a visual indication, an audio indication, or any combination thereof, and is not limited thereto. For example, the order state indication 282 can present one or more indications corresponding at least to presence, state, completion, error, or any combination thereof, of the ingredient 240, the food item including the ingredients 240, 242, 244 and 246, the order collection 254, or any combination thereof, either prepared or under preparation. For example, the order state indication 282 can include an aggregation of one or more of the state indications 270, 272 and 274, or can be based on one or more metrics, or output of one or more machine learning models corresponding to the state indications 270, 272 and 274. The supervisor user interface 280 can include a plurality of order state indications including the order state indication 282. The order state indications can correspond to orders at one or more order preparation environments including the order preparation environment 200.

For example, the system can link, based on the portion of the item data displayed a first station of the one or more stations, an expected item to a first field of view at the first station. For example, the system can receive, by a first machine learning model, sensor data detected from the first field of view. For example, the system can determine, based on the sensor data, a first geometric feature associated with a detected item in the first field of view. For example, the system can compare the first geometric feature with a second geometric feature associated with the expected item to determine if the detected item is the expected item indicated in the portion of the item data.

For example, the system can cause, in response to a determination that the first geometric feature diverges from a second geometric feature corresponding to the expected ingredient, a user interface to present an indication of divergence.

For example, the system can link, in response to a determination that the first geometric feature matches the second geometric feature, the expected item to a second field of view of a second station of the one or more stations the second station receiving the expected item from the first station.

For example, the system can detect a geometric code in the second field of view, the geometric code associated with the detected item. For example, the system can cause, in response to a determination that the geometric code is within the second field of view, the user interface to present an indication of completion corresponding to the expected item.

For example, the system can determine, based on the item data, a recipe for each item identified from the item data. For example, the system can determine, based on the recipe, the ingredient data comprising one or more ingredients used in the recipe.

For example, the system can determine, based on the ingredient data, a location for each of the one or more ingredients. For example, the system can present the location of each of the one or more ingredients on a user interface.

For example, the system can associate the order with a physical location of pick-up of the order. For example, the system can detect, based on the sensor data, a first geometric feature in a field of view corresponding to the physical location of pick-up of the order. For example, the system can compare the first geometric feature with a second geometric feature associated with the expected item to determine if the detected item is located at the physical location of pick-up of the order. For example, the system can cause, in response to a determination that the detected item is located at the physical location of pick-up of the order, a user interface corresponding to the physical location of pick-up of the order to present an indication of completion of the order or a portion of the order corresponding to the expected item.

For example, the system can cause, in response to a determination that the detected item is not located at the physical location of pick-up of the order, the user interface corresponding to the physical location of pick-up of the order to present an indication of error in the order or a portion of the order corresponding to the expected item.

For example, the non-transitory computer readable medium including one or more instructions stored thereon and executable by a processor, link, by the processor and based on the portion of the item data displayed a first station of the one or more stations, an expected item to a first field of view at the first station, receive, by the processor and via a first machine learning model, sensor data detected from the first field of view, determine, by the processor and based on the sensor data, a first geometric feature associated with a detected item in the first field of view; and compare, by the processor, the first geometric feature with a second geometric feature associated with the expected item to determine if the detected item is the expected item indicated in the portion of the item data.

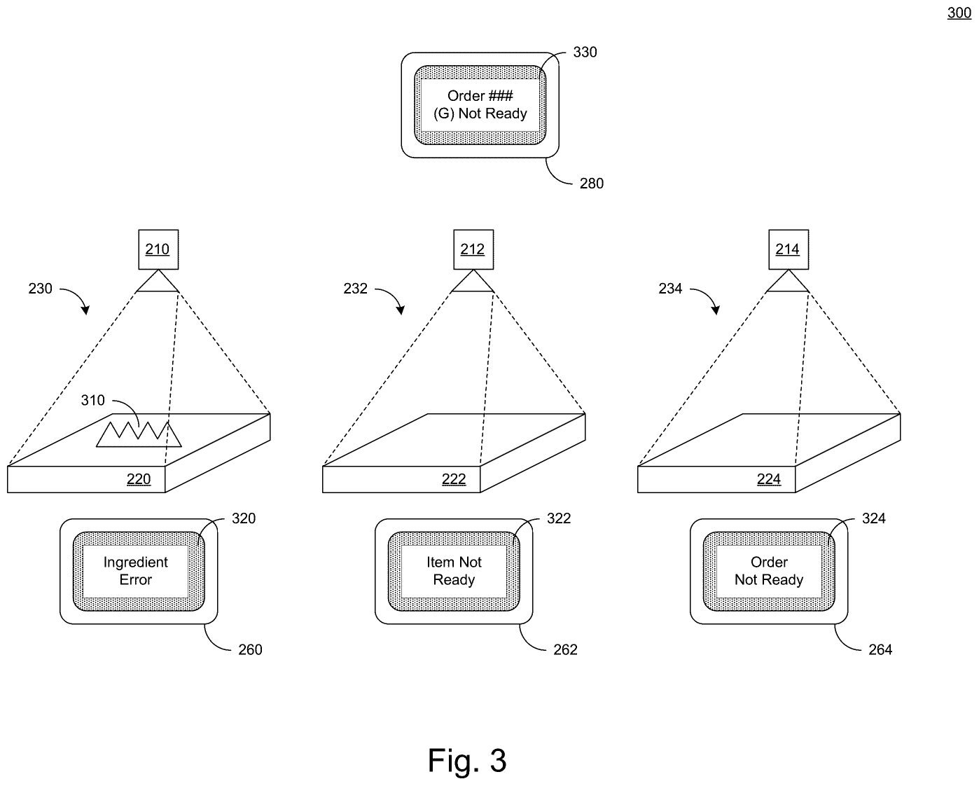

FIG. 3 depicts an example ingredient assessment state, in accordance with some embodiments. As illustrated by way of example in FIG. 3, an example ingredient assessment state 300 can include at least an ingredient 310, an ingredient error indication 320, an item error indication 322, an order error indication 324, and an order ingredient error indication 330.

The ingredient 310 can correspond to an ingredient not part of a food item linked with the ingredient preparation station 220. For example, the ingredient 310 can include a chicken breast not corresponding to a portion of a burger having a patty. The camera 210 can monitor the ingredient preparation station 220 to determine one or more of presence of the ingredient 310 and absence of the ingredient 240. For example, the camera 210 can detect when the chicken breast is removed from the ingredient preparation station 220 and the patty is placed at the ingredient preparation station 220.

The ingredient error indication 320 can include a presentation at the user interface 260 indicating that the ingredient 310 is not part of a food item linked with the ingredient preparation station 220. For example, the ingredient error indication 320 can include one or more of a visual indication, an audio indication, or any combination thereof, and is not limited thereto. For example, the ingredient error indication 320 can indicate that the ingredient 310 should be removed, or that the ingredient 310 should be replaced by the ingredient 240. For example, the ingredient user interface 260 can present the ingredient state indication 270 in response to a determination by the system 100 that the ingredient 310 is removed from the ingredient preparation station 220 and the ingredient 240 placed at the ingredient preparation station 220.

The item error indication 322 can include a presentation at the user interface 262 indicating that a food item linked with the ingredient preparation station 220 is not ready or complete. For example, the item user interface 262 can present the item state indication 272 in response to a determination by the system 100 that the ingredient 310 is removed from the ingredient preparation station 220 and the ingredient 240 placed at the ingredient preparation station 220 is prepared, and in response to detecting that the food item is prepared.

The order error indication 324 can include a presentation at the user interface 264 indicating that an order linked with the ingredient preparation station 220 is not ready or complete. For example, the order user interface 264 can present the order state indication 274 in response to a determination by the system 100 that the ingredient 310 is removed from the ingredient preparation station 220 and the ingredient 240 placed at the ingredient preparation station 220 is prepared, and in response to detecting that the order is prepared.

The order ingredient error indication 330 can include a presentation at the user interface 280 corresponding to the ingredient error indication 320. For example, the order ingredient error indication 330 can include one or more of a visual indication, an audio indication, or any combination thereof, and is not limited thereto. For example, the order ingredient error indication 330 can present one or more indications corresponding at least to presence, state, completion, error, or any combination thereof, of the ingredient 240, the ingredient 310, or any combination thereof, either prepared or under preparation. For example, the order ingredient error indication 330 can include an aggregation of one or more error indications from one or more ingredient preparation stations, or can be based on one or more metrics, or output of one or more machine learning models corresponding to the order ingredient error indication 330. For example, the order ingredient error indication 330 can identify one or more of the ingredient 240 and the ingredient 310, can identify that the ingredient 310 does not correspond with a recipe linked with a particular food item or particular order, and can identify that the ingredient 240 corresponds to a recipe linked with a particular food item or particular order. For example, the order ingredient error indication 330 can identify the item preparation station 222.

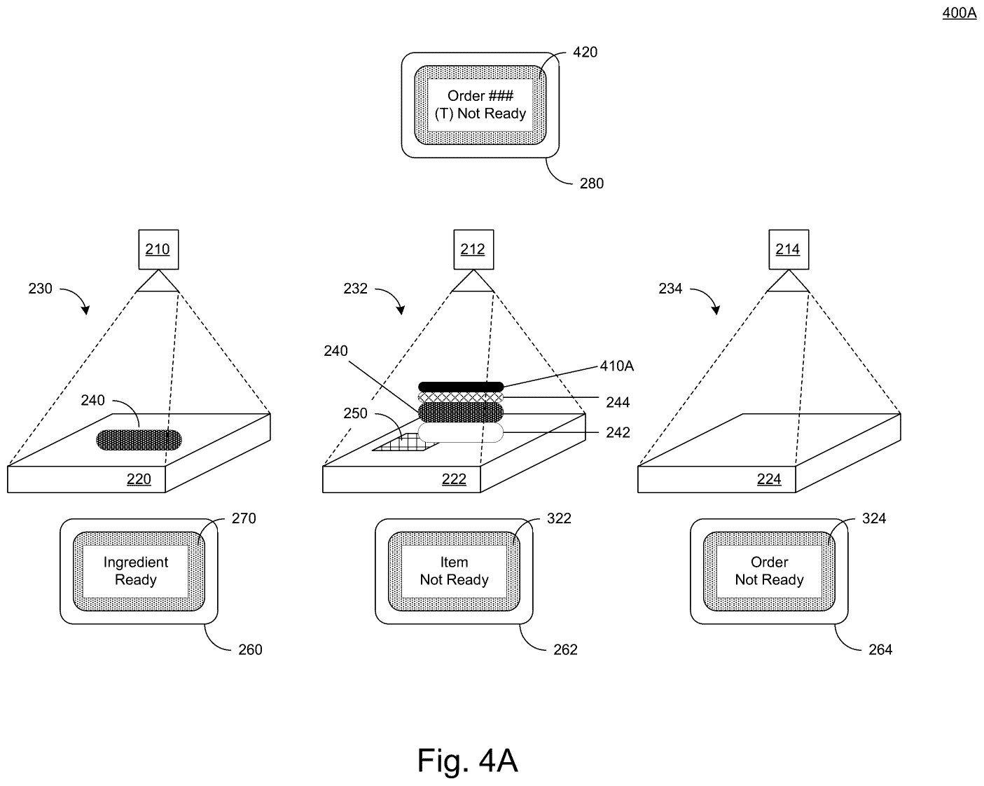

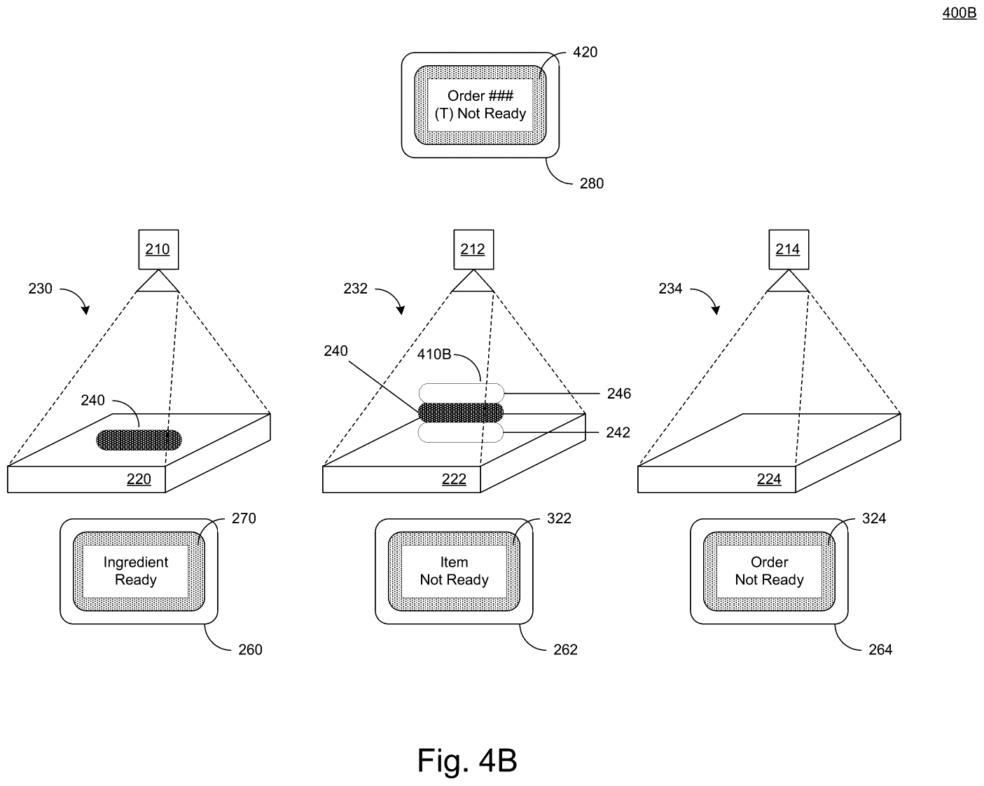

FIG. 4A depicts an example item mismatch assessment state, in accordance with some embodiments. As illustrated by way of example in FIG. 4A, an example item mismatch assessment state 400A can include at least a mismatched ingredient 410A, and an order ingredient error indication 420.

The mismatched ingredient 410A can correspond to an ingredient not part of a food item linked with the ingredient preparation station 220 and added in addition to ingredients part of a food item linked with the ingredient preparation station 220. For example, the ingredient 410A can include tomatoes not corresponding to a portion of a burger ordered with “no tomatoes.” The camera 210 can monitor the item preparation station 222 to determine presence of the ingredient 410A. For example, the camera 210 can detect when the tomato is removed from the ingredient preparation station 220 and the burger is assembly is completed according to the order linked with the item preparation station 222.

The order ingredient error indication 420 can include a presentation at the user interface 280 corresponding to the ingredient error indication 322. For example, the order ingredient error indication 420 can include one or more of a visual indication, an audio indication, or any combination thereof, and is not limited thereto. For example, the order ingredient error indication 420 can present one or more indications corresponding to presence of the ingredient 410A. For example, the order ingredient error indication 420 can include an aggregation of one or more error indications from one or more ingredient preparation stations, or can be based on one or more metrics, or output of one or more machine learning models corresponding to the order ingredient error indication 420. For example, the order ingredient error indication 330 can identify the ingredient 410A, and identify that the ingredient 410A does not correspond with a recipe linked with a particular food item or particular order. For example, the order ingredient error indication 420 can identify the item preparation station 222.

FIG. 4B depicts an example item loss assessment state, in accordance with some embodiments. As illustrated by way of example in FIG. 4B, an example item loss assessment state 400B can include at least a premature ingredient 410B.

The premature ingredient 410B can correspond to an ingredient part of a food item linked with the ingredient preparation station 220 and added in an incorrect order to ingredients part of a food item linked with the ingredient preparation station 220. For example, the premature ingredient 410B can include a top burger bun added before addition of cheese or tomatoes corresponding to a portion of a burger order. The camera 212 can monitor the item preparation station 222 to determine presence of the premature ingredient 410B. For example, the camera 210 can detect when the tomato is removed from the ingredient preparation station 220 and the burger is assembly is completed according to the order linked with the item preparation station 222.

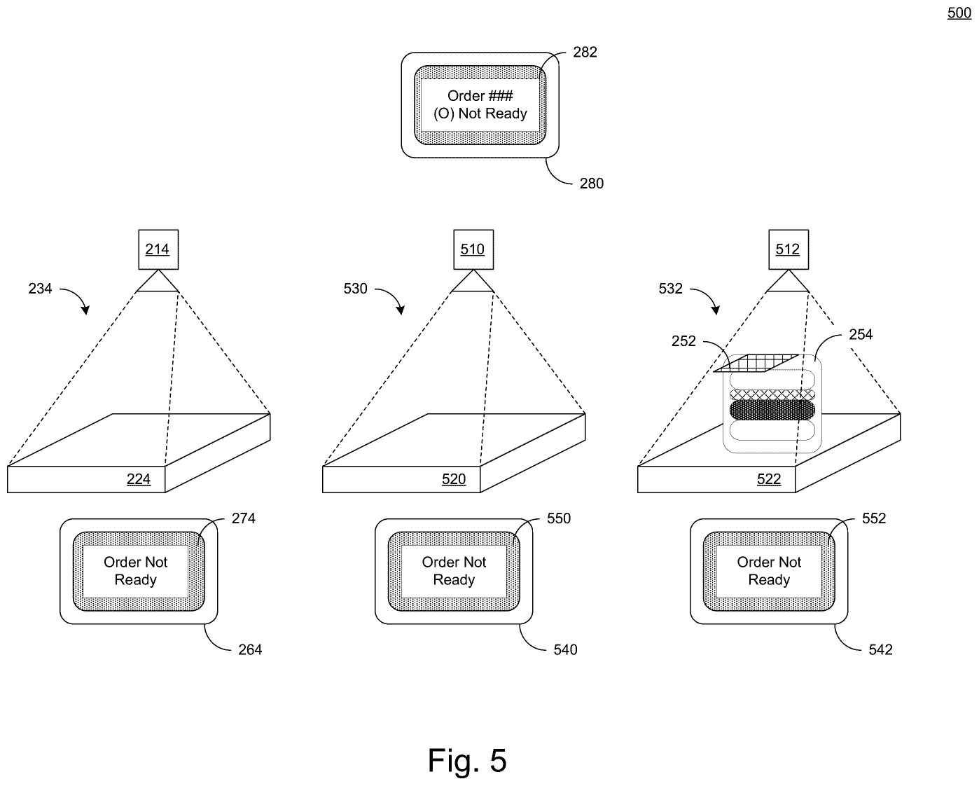

FIG. 5 depicts an example order placement assessment state, in accordance with some embodiments. As illustrated by way of example in FIG. 5, an example order placement assessment state 500 can include at least destination cameras 510 and 512, order preparation stations 520 and 522, an expected order location 530, a detected order location 532, an order station user interfaces 540 and 542, and an order error indications 550 and 552. The destination cameras 510 and 512 can be oriented in the order preparation environment 200 with respect to one or more order placement stations. The configuration of destination cameras 510 and 512 is not limited to the configuration or placement as illustrated herein by way of example, and can include an arbitrary number of cameras each associated with an arbitrary number of physical locations based on or customized to a specific order preparation environment or a specific type or group of order preparation environment. The order preparation stations 520 and 522 can correspond to respective physical locations where one or more orders are prepared, distinct from the order preparation station 224.

The expected order location 530 can be linked with a particular order corresponding to the applied order indicator 252. For example, the system 100 can determine that the order corresponding to the applied order indicator 252 is complete, in response to placement of the order with the applied order indicator 252 at the expected order location 530, and only at the expected order location 530. For example, the system 100 can determine that the order linked with the expected order location 530 is complete, in response to placement of the order at the expected order location 530, and only at the expected order location 530. The detected order location 532 can be separate from the expected order location 530. For example, the system 100 can determine that the order corresponding to the applied order indicator 252 is not complete, in response to placement of the order with the applied order indicator 252 at the detected order location 532, and not at the expected order location 530. For example, the system 100 can determine that the order linked with the expected order location 530 is not complete, in response to placement of the order at the detected order location 532, and not at the expected order location 530. For example, the expected order location and the detected order location 532 can respectively be at least partially within respective fields of view of the destination cameras 510 and 512.

The order station user interfaces 540 and 542 can correspond at least partially in one or more of structure and operation to the order user interface 264, and can respectively be linked with the order preparation stations 520 and 522. The order error indications 550 and 552 can respectively include presentations at the user interfaces 540 and 542 indicating that no order linked specifically with the order preparation stations 520 or 522 is ready or complete.

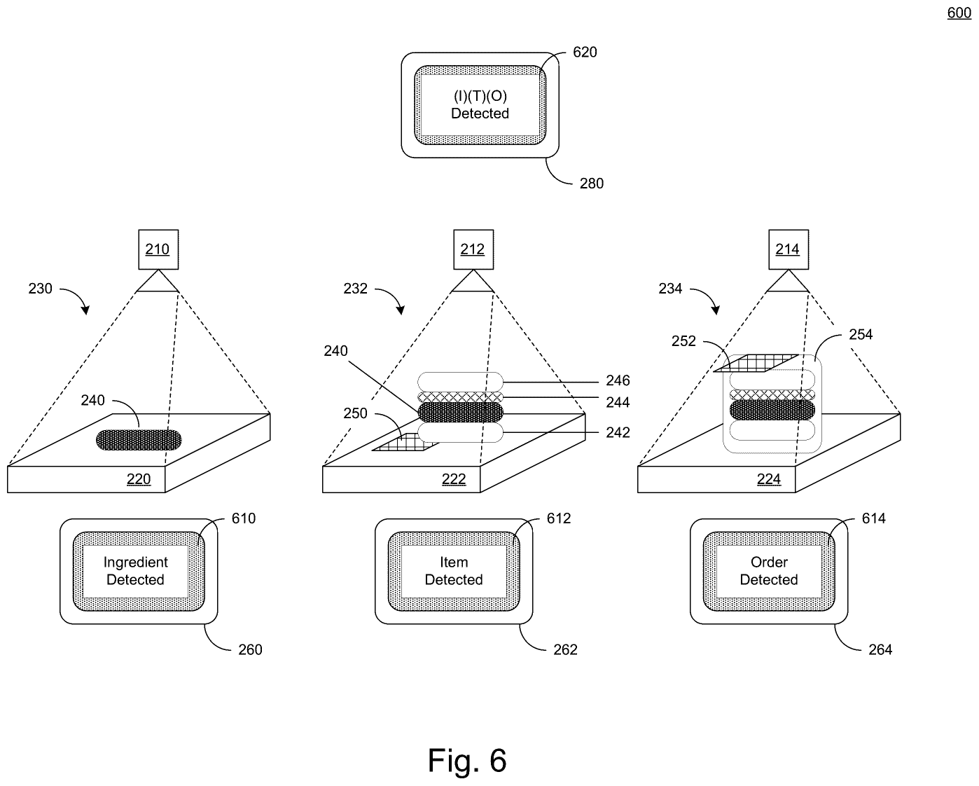

FIG. 6 depicts an example preparation training state, in accordance with some embodiments. As illustrated by way of example in FIG. 6, an example preparation training state 600 can include at least an ingredient identification indication 610, an item identification indication 612, an order identification indication 614, and a preparation training state indication 620.

The ingredient identification indication 610 can include a presentation at the user interface 260 identifying a property of the ingredient 610. For example, the ingredient identification indication 610 can include one or more of a visual indication, an audio indication, or any combination thereof, and is not limited thereto. For example, the ingredient identification indication 610 can present one or more indications indicating that a feature or metric detected via the camera 210 is extracted into one or more sub-metrics 166. The item identification indication 612 can include a presentation at the user interface 260 identifying a property of the ingredient 240. For example, the item identification indication 612 can include one or more of a visual indication, an audio indication, or any combination thereof, and is not limited thereto. For example, the item identification indication 612 can present one or more indications indicating that a feature or metric detected via the camera 212 is extracted into one or more object metrics 162 or sub-object metrics 166. The order identification indication 614 can include a presentation at the user interface 260 identifying a property of a food item based on one or more of the ingredients 240, 242, 244 and 246. For example, the order identification indication 614 can include one or more of a visual indication, an audio indication, or any combination thereof, and is not limited thereto. For example, the order identification indication 614 can present one or more indications indicating that a feature or metric detected via the camera 214 is extracted into one or more object metrics 162.

The preparation training state indication 620 can include a presentation at the user interface 280 corresponding to one or more of the identification indications 610, 612 and 614. For example, the preparation training state indication 620 can include one or more of a visual indication, an audio indication, or any combination thereof, and is not limited thereto. For example, the preparation training state indication 620 can present one or more indications corresponding at least to detection of one or more ingredients, items, and orders. For example, the preparation training state indication 620 can include an aggregation of one or more of the identification indications 610, 612 and 614, or can be based on one or more metrics, or output of one or more machine learning models corresponding to the identification indications 610, 612 and 614. The supervisor user interface 280 can include a plurality of training state indications including the preparation training state indication 620. The training state indications can correspond to detections of training at one or more order preparation environments including the order preparation environment 200.

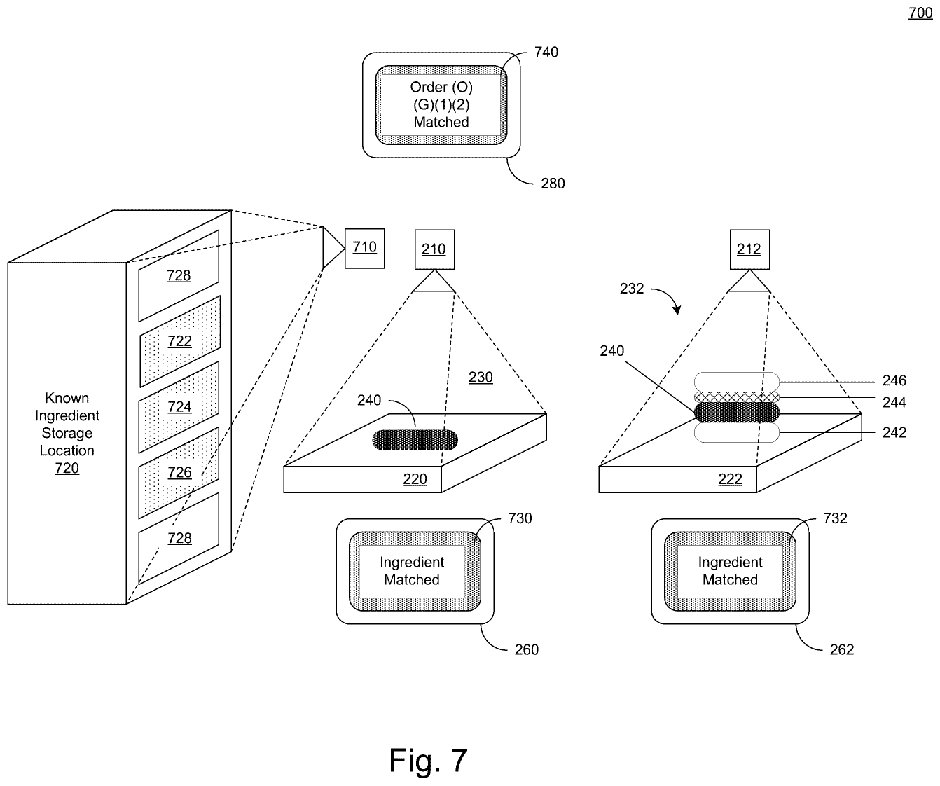

FIG. 7 depicts an example ingredient storage training state, in accordance with some embodiments. As illustrated by way of example in FIG. 7, an example ingredient storage training state 700 can include at least an ingredient storage camera 710, a known ingredient storage location 720, retrieved ingredient locations 722, 724, 726, and 728, ingredient storage identification indications 730 and 732, and an order sourcing identification indication 740. Although the ingredient storage location 720 is shown as having a particular configuration, in other embodiments, the configuration of the ingredient storage location can vary. For example, in some embodiments, the ingredient storage location 720 can be horizontally oriented instead of vertically. In some embodiments, the ingredient storage location 720 can include a plurality of stand-alone bins or buckets or other storage mediums to store the ingredients. The ingredient storage location 720 can include other configurations. Also, although five of the ingredient locations 722, 724, 726, and 728 are shown in FIG. 7, in other embodiments, additional or fewer ingredient locations can be provided.

The ingredient storage camera 710 can be oriented in the order preparation environment 200 with respect to the known ingredient storage location 720. The known ingredient storage location 720 can correspond, for example, to a pantry, a storage bin, a refrigerator, a freezer, a basket, a plurality thereof, or any combination thereof. The retrieved ingredient locations 722, 724 and 726 can correspond to portions of the known ingredient storage location 720 matched with one or more ingredients obtained for an order or food item. For example, the retrieved ingredient locations 722, 724 and 726 can respectively correspond to a freezer for patties of a burger, a refrigerator for cheese of a burger, and a refrigerator for buns of a burger. The ingredient locations 728 can correspond to portions of the known ingredient storage location 720 not matched with one or more ingredients obtained for an order or food item. For example, the ingredient locations 728 can correspond to a refrigerator for black beans, not associated with a recipe or ingredients for a burger. For example, a match as discussed herein with respect to an ingredient, item, order, or code can correspond to a correspondence of at least a portion of two objects under comparison. The match need not be an exact match, and can include a fuzzy match satisfying any threshold below a threshold corresponding to an indication of identicality between two objects.

The ingredient storage identification indications 730 and 732 can respectively indicate that ingredients have been detected respectively at the preparation stations 220 and 222. For example, the ingredient storage identification indication 730 can indicate that a first ingredient, corresponding to the patty 240, is detected at the item preparation station 220, and the ingredient storage identification indication 732 can indicate that one or more ingredients, corresponding to one or more of the ingredients 242, 244 and 246, are detected at the item preparation station 222.

The order sourcing identification indication 740 can include a presentation at the user interface 280 corresponding to one or more of the identification indications 730 and 732. For example, the order sourcing identification indication 740 can include one or more of a visual indication, an audio indication, or any combination thereof, and is not limited thereto. For example, the order sourcing identification indication 740 can present one or more indications corresponding at least to detection of one or more ingredients. For example, the order sourcing identification indication 740 can include an aggregation of one or more of the identification indications 730 and 732, or can be based on one or more metrics, or output of one or more machine learning models corresponding to the identification indications 730 and 732. The supervisor user interface 280 can include a plurality of training state indications including the order sourcing identification indication 740. The training state indications can correspond to detections of training at one or more order preparation environments including the order preparation environment 200.

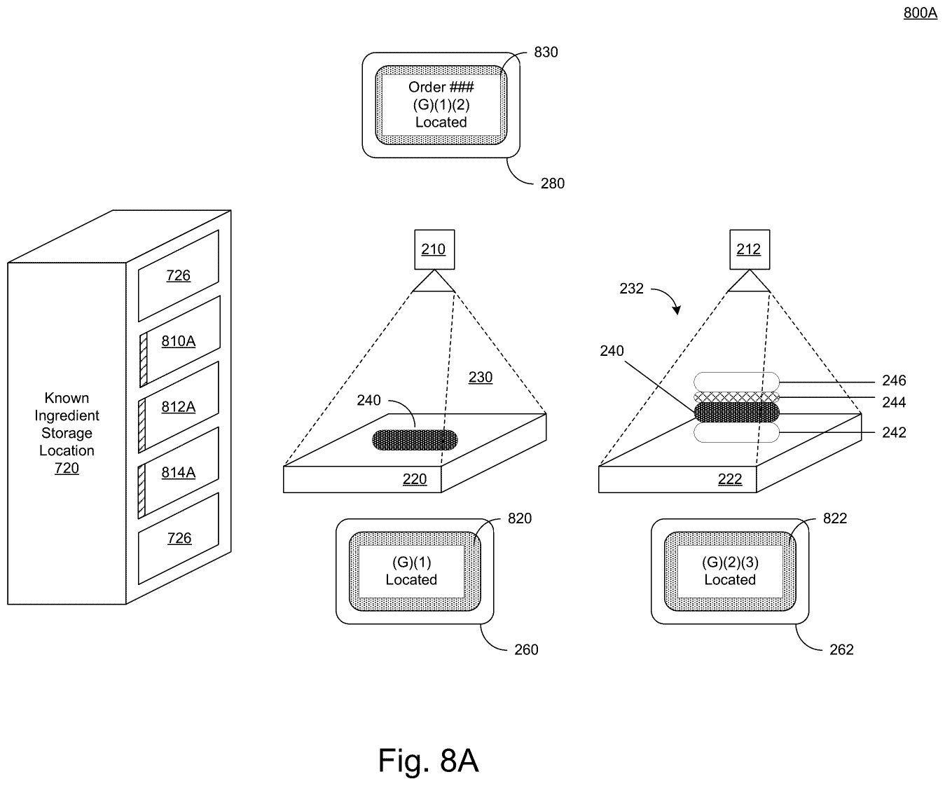

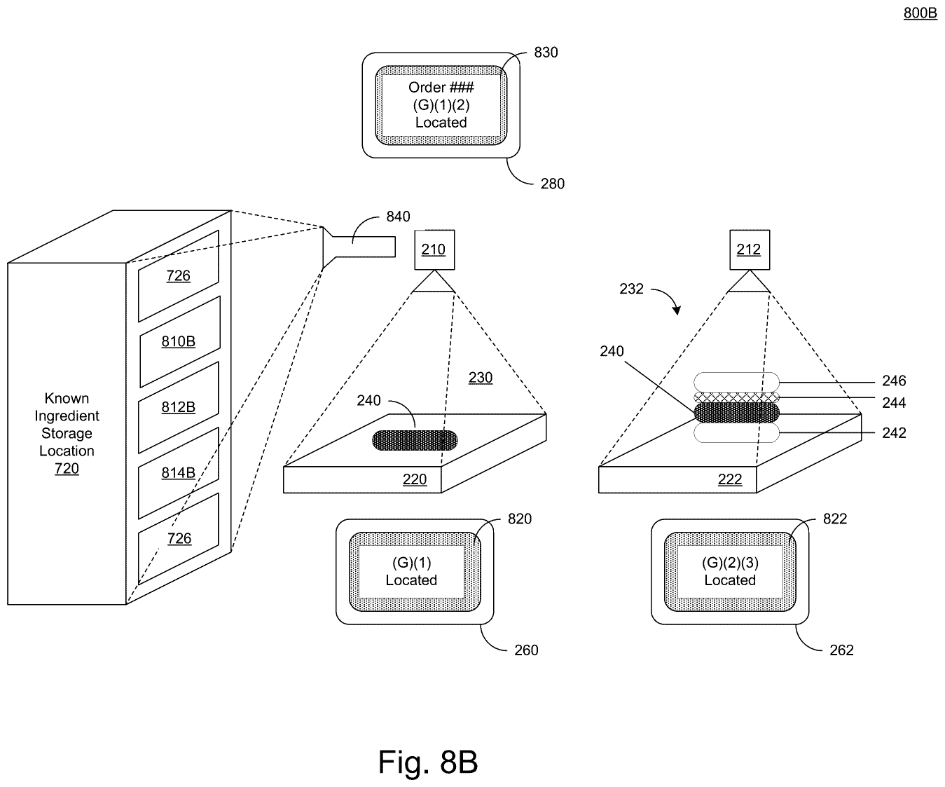

FIG. 8A depicts an example ingredient retrieval state, in accordance with some embodiments. As illustrated by way of example in FIG. 8A, an example ingredient retrieval state 800A can include at least an ingredient storage locations augmented with interface devices 810A, 812A and 814A, ingredient location indications 820 and 822, and an ingredient location success indication 830.

The ingredient storage locations augmented with interface devices 810A, 812A and 814A can include one or more indication elements to indicate location of a particular ingredient corresponding to a particular food preparation action at a particular food preparation station. For example, the interface devices 810A, 812A and 814A can correspond to lights having various colors output or brightness output capabilities installed in or mounted to the known ingredient storage location 720. The hub system 120 or a component thereof can activate one or more of the interface devices 810A, 812A and 814A in coordination with one or more of the ingredient location indications 820 and 822.

The ingredient location indications 820 and 822 can indicate a location at the known ingredient storage location 720 having a particular ingredient corresponding to a particular food preparation station. For example, the ingredient location indications 820 and 822 can respectively indicate that a first ingredient, corresponding to the patty 240, is located at a storage location corresponding to the interface device 810A, and the ingredient location indications 822 can indicate that one or more ingredients, corresponding to one or more of the ingredients 242, 244 and 246, are located at a storage location corresponding to the interface device 812A and 814A.

The ingredient location success indication 830 can include a presentation at the user interface 280 corresponding to one or more of the ingredient location indications 820 and 822. For example, the ingredient location success indication 830 can include one or more of a visual indication, an audio indication, or any combination thereof, and is not limited thereto. For example, the ingredient location success indication 830 can include an aggregation of one or more of the ingredient location indications 820 and 822, or can be based on one or more metrics, or output of one or more machine learning models corresponding to the ingredient location indications 820 and 822. The supervisor user interface 280 can include a plurality of training state indications including the ingredient location success indication 830. The training state indications can correspond to detections of training at one or more order preparation environments including the order preparation environment 200.

FIG. 8B depicts an example ingredient retrieval state, in accordance with some embodiments. As illustrated by way of example in FIG. 8B, an example ingredient retrieval state 800B can include at least an ingredient storage locations 810B, 812B and 814B, and an ingredient locating device 840.

The ingredient storage locations 810B, 812B and 814B can correspond at least partially in one or more of structure and operation to the retrieved ingredient locations 722, 724 and 726. The ingredient locating device 840 can include one or more indication elements to indicate location of a particular ingredient corresponding to a particular food preparation action at a particular food preparation station. For example, the ingredient locating device 840 can selectively project light having various colors output or brightness output capabilities onto the ingredient storage locations 810B, 812B and 814B of the known ingredient storage location 720. The hub system 120 or a component thereof can activate ingredient locating device 840 in coordination with one or more of the ingredient location indications 820 and 822.

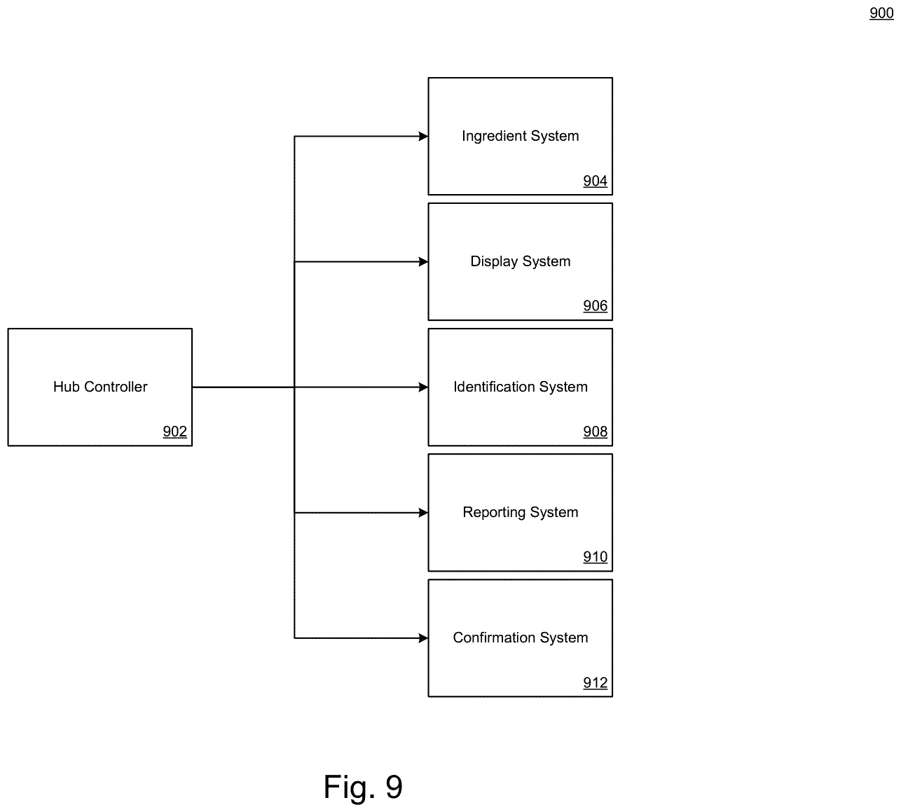

FIG. 9 depicts an example hub system, in accordance with some embodiments. As illustrated by way of example in FIG. 9, an example hub system 900 can include at least a hub controller 902, an ingredient system 904, a display system 906, an identification system 908, a reporting system 910, and a confirmation system 912. The hub system 900 can correspond at least partially in one or more of structure and operation to the hub system 120.

The hub controller 902 can coordinate execution of the ingredient system 904, the display system 906, the identification system 908, reporting system 910, and the confirmation system 912. The ingredient system 904 can correlate one or more ingredients to one or more items and orders via the order correlation engine 130. The display system 906 can instruct one or more of the user interfaces 172, 260, 262, 264, 280, 540 and 542, to present one or more indications as discussed herein, via one or more of the order correlation engine 130, the feature recognition engine 132, the position recognition engine 140, and the object identification engine 150. The identification system 908 can identify one or more ingredients at one or more preparation stations or storage locations, via one or more of the feature recognition engine 132, the position recognition engine 140, and the object identification engine 150.

The reporting system 910 can capture one or more reaction metrics 168 in response to activity detected by one or more of the cameras 170, 210, 212, 214, 510, 512 and 710, via one or more of the feature recognition engine 132, the position recognition engine 140, and the object identification engine 150. The confirmation system 912 can determine completion of one or more ingredients, items or orders based on placement of particular ingredients, items or orders at particular physical locations or stations, via one or more of the feature recognition engine 132, the position recognition engine 140, and the object identification engine 150.

For example, the system can link, based on the item data, an expected item to a first field of view at a station among the stations corresponding to assembly of the expected item. The system can detect, by a first machine learning model receiving input corresponding to the first field of view, a first geometric feature in the first field of view, the first machine learning model trained with input can include a plurality of ingredients can include an expected ingredient linked with the expected item and corresponding to the ingredient data.

For example, the system can cause, in response to a determination that the first geometric feature diverges from a second geometric feature corresponding to the expected ingredient, a user interface to present an indication of divergence. For example, the system can link, in response to a determination that the first geometric feature matches a second geometric feature corresponding to the expected ingredient, the expected item to a second field of view for a second station among the stations corresponding to a location of transfer of the expected item. For example, the system can detect a geometric code in the second field of view. For example, a geometric code can correspond to a machine-readable pattern as discussed herein, including but not limited to a QR code. The system can cause, in response to a determination that the geometric code is within the second field of view, the user interface to present an indication of completion.

For example, the system can detect, by a second machine learning model receiving input corresponding to the second field of view, a third geometric feature in the second field of view, the second machine learning model trained with input can include a plurality of items can include the expected item. For example, the system can cause, in response to a determination that the third geometric feature diverges from a fourth geometric feature corresponding to the expected item, a user interface to present an indication of divergence. For example, the system can cause, in response to a determination that the third geometric feature matches the fourth geometric feature, the user interface to present an indication of completion corresponding to the expected item. For example, the system can cause, in response to a determination that the first geometric feature matches a second geometric feature corresponding to the expected ingredient, the user interface to present an indication of completion corresponding to the expected ingredient.

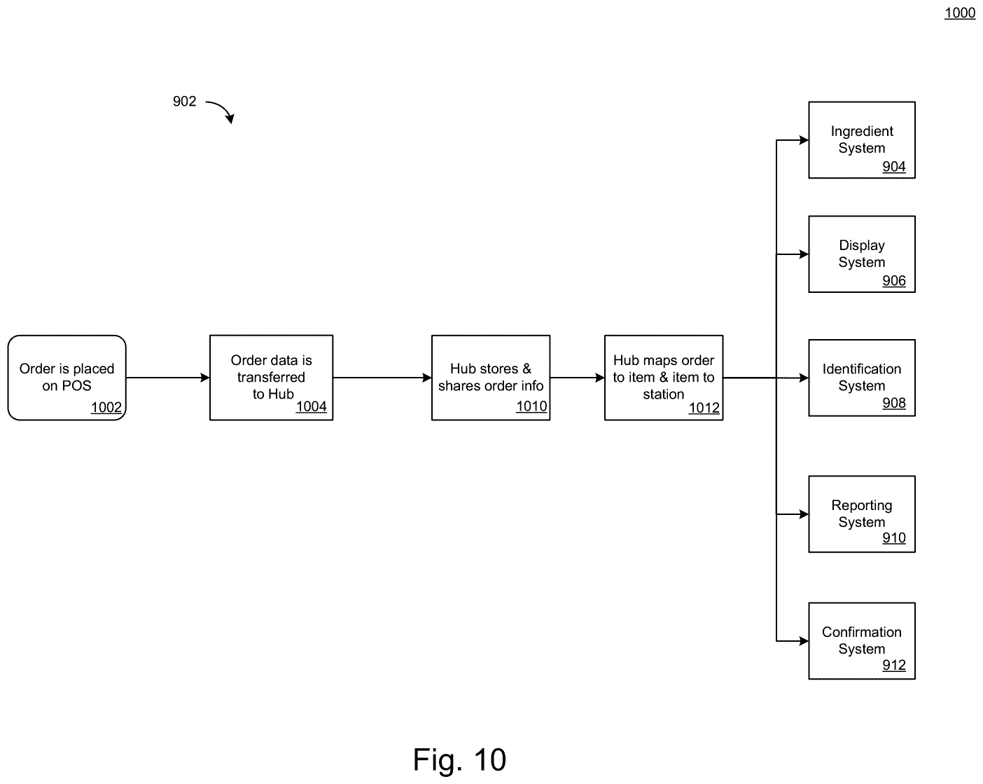

FIG. 10 depicts an example hub controller process, in accordance with some embodiments. At least the system 100 or the hub controller 902 of the hub system 120 can perform method 1000. At 1002, the method 1000 receives an order placed on a point of sale (POS) device (e.g., a POS device at a restaurant). At 1004, the method 1000 transfers order data to a hub system. For example, the hub system can correspond to the hub system 900 or 120. For example, the method 1000 can communicate with the hub system via a direct POS integration. For example, the method 1000 can communicate via a 3rd party POS integrator. At 1010, the method 1000 stores and shares order information, received from 1004, with one or more of the hub controller 902 or the hub system 120 or 900. At 1012, the method 1000 maps the order information to an item and map an item to a station. For example, part of the order information can be mapped to one or more food preparation station corresponding to a particular food item. For example, a first portion of order information for a burger food item can be transmitted to a first food preparation station corresponding to preparation of the patty, and a second portion of order information for the burger food item can be transmitted to a second food preparation station corresponding to assembly of the burger. There correspondences can be predetermined or can be identified in accordance with a training process of hub system 120 or 900. For example, mapping of an order can occur via input received via the supervisor user interface 280, or partially or fully via the order correlation engine 130 or the object identification engine or the machine learning models corresponding thereto. The hub then transmits one or more portions of the order information to one or more of the ingredient system 904, the display system 906, the identification system 908, the reporting system 910, and the confirmation system 912.

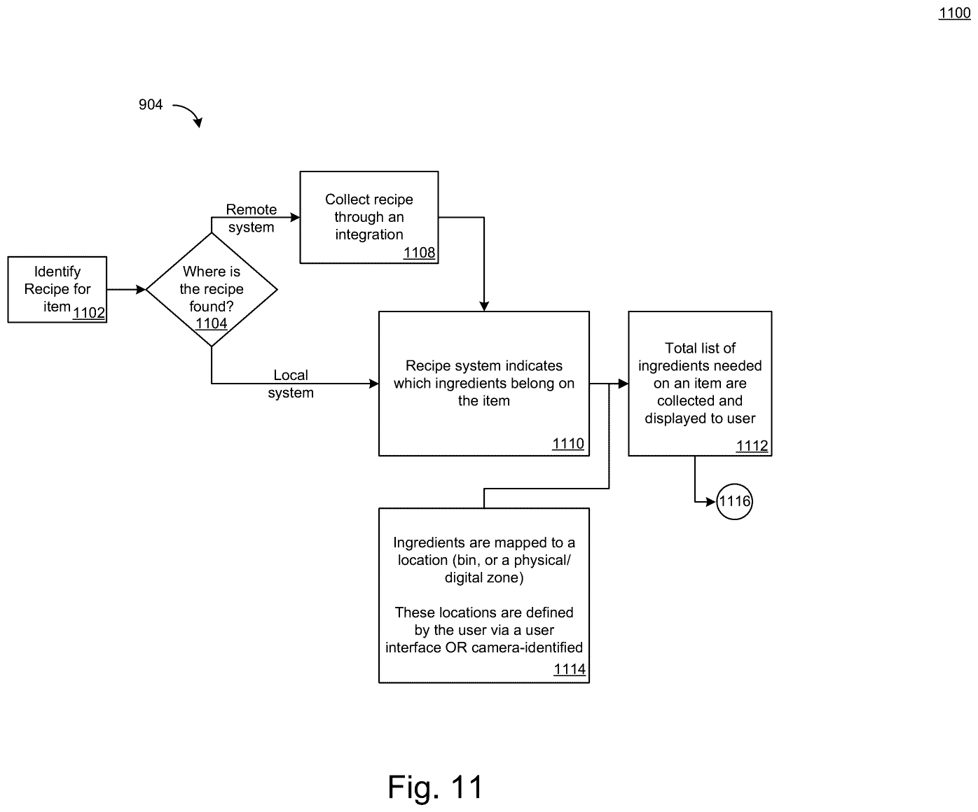

FIG. 11 depicts an example ingredient system process, in accordance with some embodiments. For example, the ingredient system process can correspond to an identification of one or more ingredients of one or more food items indicated by one or more orders. At least the system 100 or the ingredient system 904 of the hub system 120 can perform method 1100. At 1102, the method 1100 identifies a recipe corresponding to an item and links a food item indicated by the order information to a recipe. For example, for order information identifying a cheeseburger, the method 1100 can obtain a recipe for preparing a cheeseburger. At 1104, the method 1100 obtain a recipe by either a local recipe stored as sub-object metrics 166 or from a remote source. At 1108, the method 1100 obtains the recipe through an integration with a remote system or at 1110 through a local system.

At 1110, the method 1100 indicates which ingredients belong on the items based on the obtained recipe. For example, added or removed ingredients can also be obtained from the hub via a supervisor user interface or a POS device. At 1112, the method 1100 collects and displays, to a user, a total list of ingredients needed to assemble an item via indications including lights, sounds, or visuals. For example, the method 1100 can illuminate a storage location of one or more ingredients as discussed herein in FIGS. 8A-B. At 1114, the method 1100 maps one or more ingredients to one or more storage locations for those particular ingredients defined by the user via a user interface or camera. For example, the method 1100 can identify a storage location of one or more ingredients as discussed herein in FIGS. 8A-B. At 1116, the method 1100 outputs ingredients to one or more user interfaces associated with one or more food or order preparation stations, or supervisor user interfaces corresponding to those food or order preparation stations. For example, the ingredient system process can be performed with respect to one or more orders, to identify one or more recipes and ingredients of the orders.

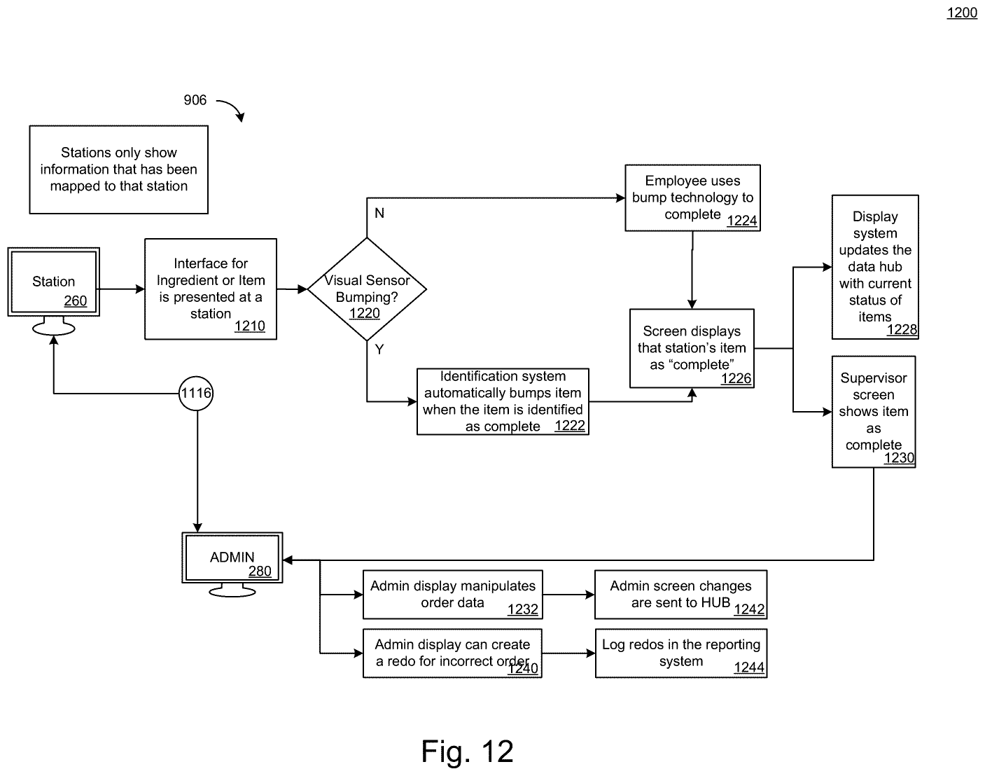

FIG. 12 depicts an example display system process, in accordance with some embodiments. At least the system 100 or the display system 906 of the hub system 120 can perform method 1200.

At 1210, the method 1200 instructs one or more stations to only show information that has been mapped to that station. For example, a station can correspond to station 260. At 1220, the method 1200 selects a visual bumping system or an employee bumping system. For example, the method 1200 can bump via an integration with bumping hardware. For example, the method 1200 can use bump technology including visual completion detection via machine learning model to indicate completion of preparation of an ingredient, item, or order. At 1222, the method 1200 automatically bumps an item when the item is identified as complete. At 1224, the method 1200 uses a display system to bump via hardware.

At 1226, the method 1200 displays via a user interface at a station that an item at that station is complete. At 1228, the method 1200 updates the data hub with current status of items. At 1230, the method 1200 updates the supervisor user interface 280 to show an item as complete. At 1232, the method 1200 receives a modification to order data via the supervisor user interface 280. For example, the supervisor user interface 280 can receive an indication of modification of an order to remove an ingredient (‘no tomatoes’), add an ingredient (‘add pickles’) or substitute an ingredient (‘veggie patty’). At 1240, the method 1200 receives an indication via the supervisor user interface 280 to redo an incorrect order. At 1242, the method 1200 transmits changes via the supervisor user interface 280 to the hub controller 902 as one or more reaction metrics 168. At 1244, the method 1200 logs re-dos by the reporting system as one or more reaction metrics 168. At 1246, the method 1200 outputs logging to the system memory as one or more reaction metrics 168.

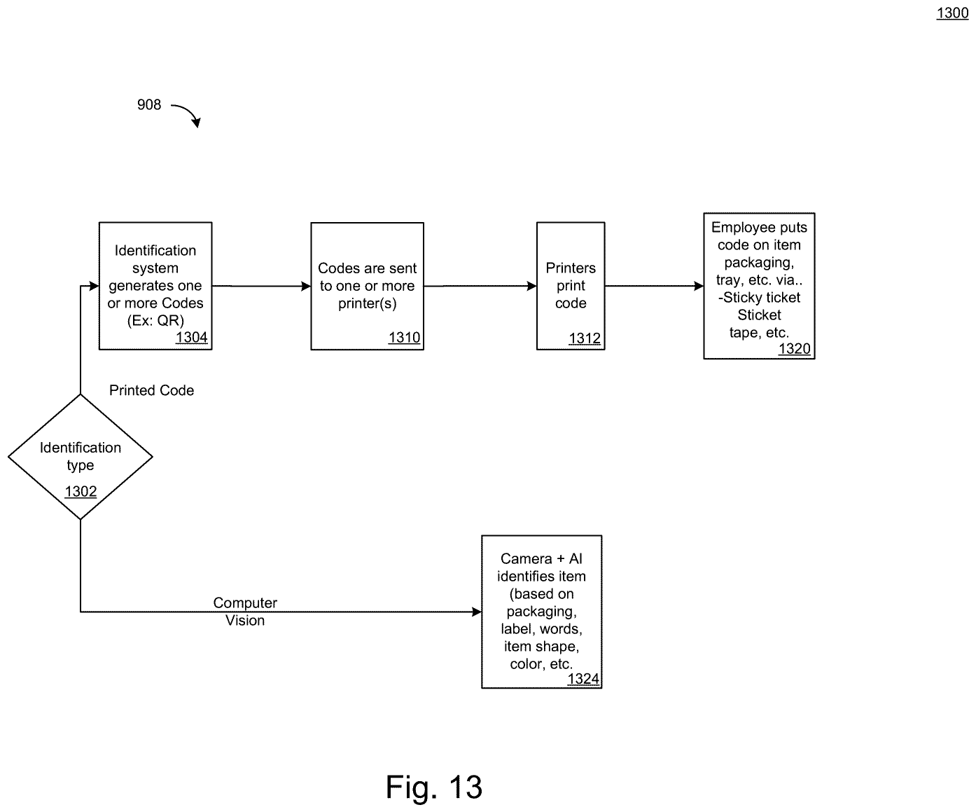

FIG. 13 depicts an example identification system, in accordance with some embodiments. At least the system 100 or the identification system 908 of the hub system 120 can perform method 1300.

At 1302, the method 1300 determines an identification type of an ingredient, item or order. At 1304, the method 1300 generates one or more codes. For example, each code contains information that can map to one or more of an order number, item information, and customer information. For example, the code can correspond to an order indicator 250.

At 1310, the method 1300 sends the codes to one or more printers. At 1312, the method 1300 instructs one or more printers to print the codes. For example, the method 1300 can detect that the code is applied to an item. For example, the code can correspond to the applied order indicator 252. For example, the method 1300 can output the code to the hub controller 902 or any component thereof. At 1324, the method 1300 identifies the item by a camera and at least one trained machine learning model as discussed herein.

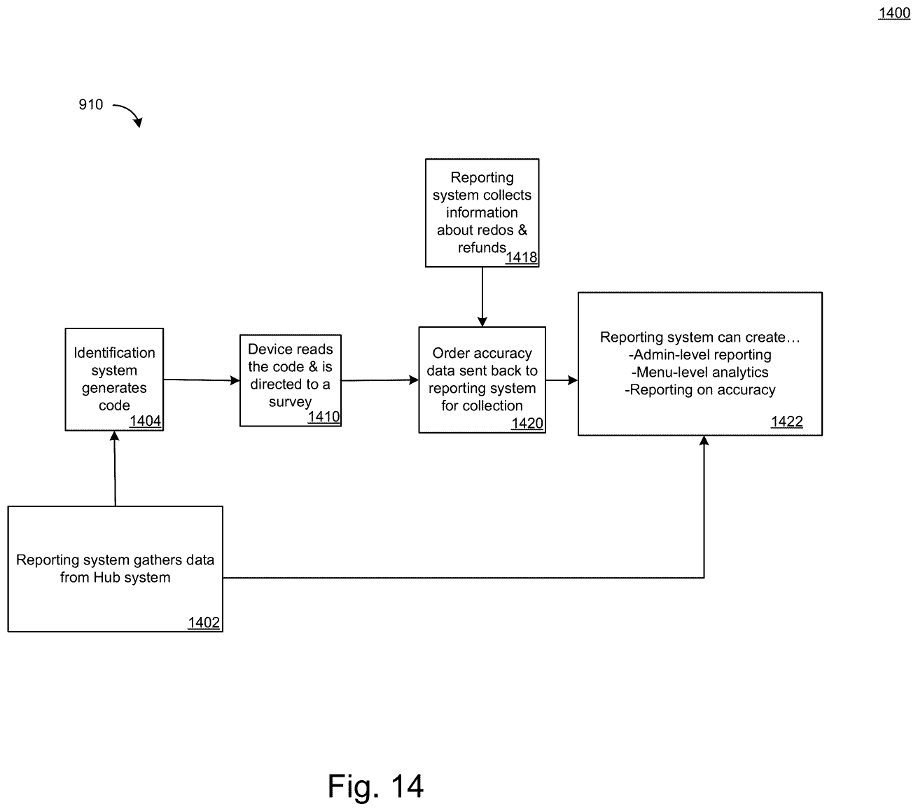

FIG. 14 depicts an example reporting system process, in accordance with some embodiments. At least the system 100 or the reporting system 910 of the hub system 120 can perform method 1400. At 1402, the method 1400 gathers data and one or more reactions metrics 168. For example, the reaction metrics gathered at 1402 can include service times corresponding to time from reception of an order to completion of the order or any item or ingredient associated with the order. For example, the reaction metrics gathered at 1402 can include mistakes during assembly of a food item, mistakes during expediting preparation of an order, item or ingredient. For example, expediting can correspond to placing an order or modification to an order or a portion thereof in a queue at a position different than an order in which the order or modification to the order or the portion thereof was received at the hub controller 902 or hub system 102 or 900.

At 1404, the method 1400 generates a code corresponding to the order or the completion of the order. At 1410, the method 1400 instructs a device to the survey via the code. For example, the method 1400 can cause the survey to be presented at the device. For example, the method 1400 can direct the device to a 3rd party if the survey is provided by a 3rd party, via a URL. For example, the method 1400 can direct the device to a survey URL. At 1418, the method 1400 collects information about re-dos and refunds as reaction metrics 168. At 1420, the method 1400 orders accuracy data corresponding to orders sent to the system memory 160 as one or more reaction metrics 168. At 1422, the method 1400 creates reporting for analytics and/or accuracy based on the reaction metrics. For example, the method 1400 can report system records errors and/or timing as one or more reaction metrics 168.

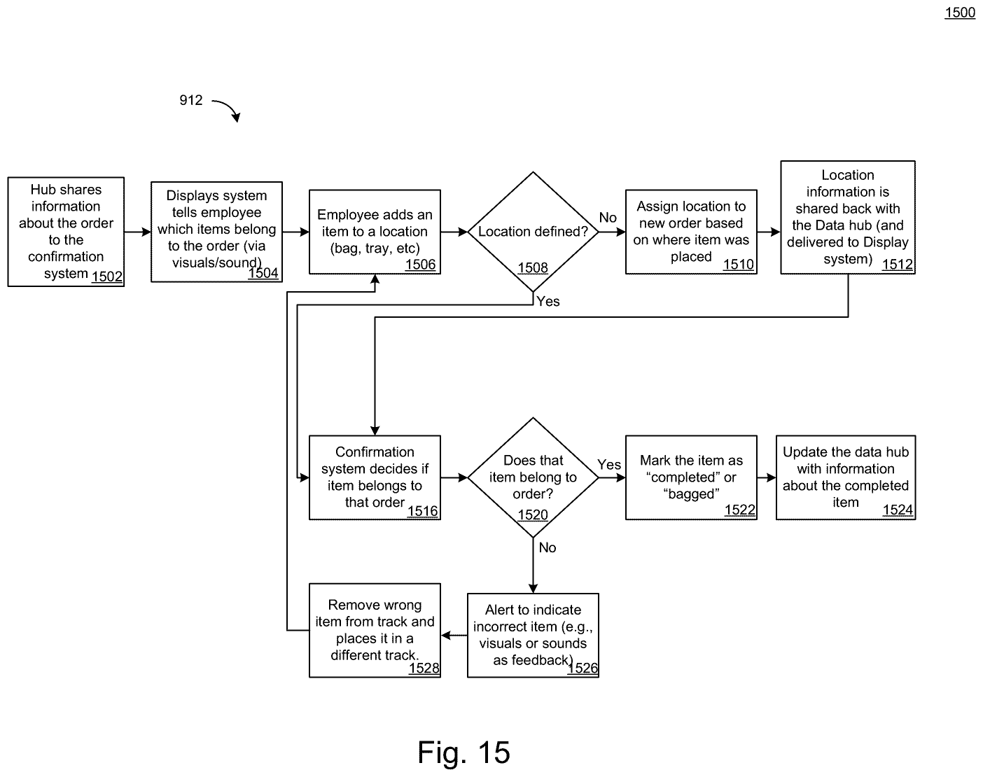

FIG. 15 depicts an example confirmation system process, in accordance with some embodiments. At least the system 100 or the confirmation system 912 of the hub system 120 can perform method 1500.

At 1502, the method 1500 shares information about the order via the confirmation system. At 1504, the method 1500 indicates via a user interface which items belong to the order. At 1506, the method 1500 links an item to a location. For example, a location can correspond to a physical object or digitally defined. For example, a location can correspond to a field of view or a portion thereof. The method 1500 can dynamically change size of a location based on the size of the order. At 1508, the method 1500 identifies a location. At 1510, the method 1500 assigns a location to new order based on an identification of a location of placement of the item. At 1512, the method 1500 shares and presents location information. At 1516, the method 1500 instructs the confirmation system to determine whether an item belongs to an order. At 1520, the method 1500 determines whether an item belongs to an order. At 1522, the method 1500 marks the item as completed or bagged. At 1524, the method 1500 updates the data hub with information about the completed item. At 1526, the method 1500 generates an indication or alert to indicate incorrect item. At 1528, the method 1500 removes wrong item from track and place it in a different track.

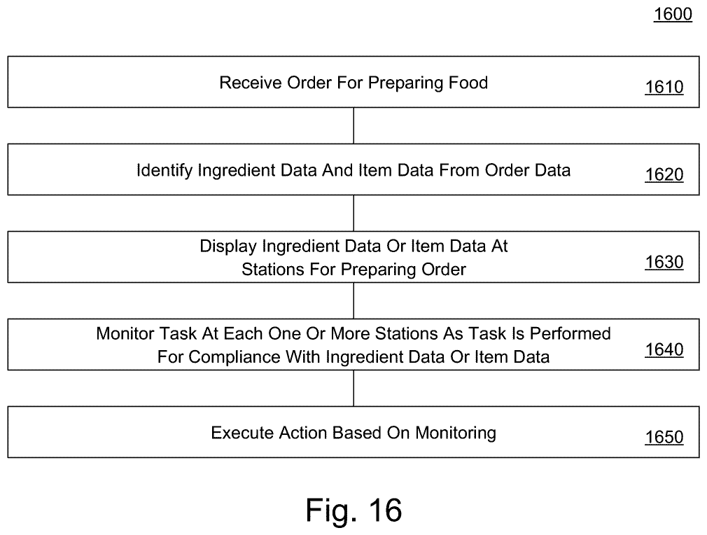

FIG. 16 depicts an example method of identification and verification of accuracy of food assembly, in accordance with some embodiments. At least the system 100 or the hub system 120, or any component thereof, can perform method 1600. At 1610, the method 1600 receives an order for preparing food. At 1620, the method 1600 identifies ingredient data and item data from the order data. At 1630, the method 1600 displays ingredient data or item data at stations for preparing the order. At 1640, the method 1600 monitors the task at each the one or more stations as the task is performed for compliance with the ingredient data or the item data. At 1650, the method 1600 executes an action based on the monitoring.

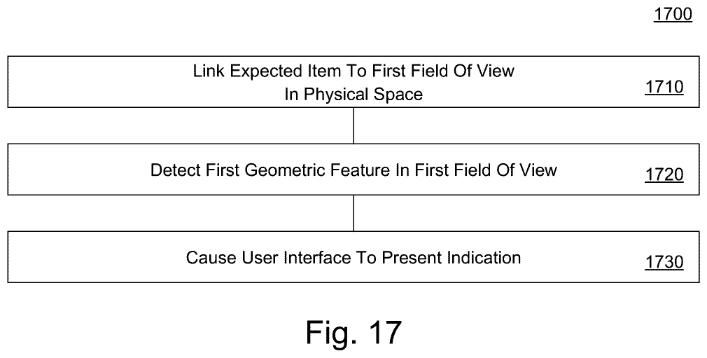

FIG. 17 depicts an example method of identification and verification of accuracy of food assembly via machine learning, in accordance with some embodiments. At least the system 100 or the hub system 120, or any component thereof, can perform method 1700. At 1710, the method 1700 links the expected item to a first field of view in a physical space. The item can be an edible item (e.g., burger) or a non-edible item (e.g., silverware for the order, box containing an edible item, etc.). At 1720, the method 1700 detects a first geometric feature in the first field of view. At 1730, the method 1700 causes a user interface to present an indication.

For example, the monitoring can include linking, based on the portion of the item data displayed a first station of the one or more stations, an expected item to a first field of view at the first station, receiving, by a first machine learning model, sensor data detected from the first field of view, determining, based on the sensor data, a first geometric feature associated with a detected item in the first field of view, and comparing the first geometric feature with a second geometric feature associated with the expected item to determine if the detected item is the expected item indicated in the portion of the item data.

For example, the action can include causing, in response to determining that the first geometric feature diverges from the second geometric feature, a user interface to present an indication of divergence.

For example, the action can include linking, in response to determining that the first geometric feature matches the second geometric feature, the expected item to a second field of view of a second station of the one or more stations, the second station receiving the expected item from the first station.

For example, the method can include detecting a geometric code in the second field of view, the geometric code associated with the detected item, and causing, in response to determining that the geometric code is within the second field of view, the user interface to present an indication of completion corresponding to the expected item.

For example, the method can include determining, based on the item data, a recipe for each item identified from the item data, and determining, based on the recipe, the ingredient data comprising one or more ingredients used in the recipe.

For example, the method can include determining, based on the ingredient data, a location for each of the one or more ingredients, and presenting the location of each of the one or more ingredients on a user interface.

For example, the method can include associating the order with a physical location of pick-up of the order, detecting, based on the sensor data, a first geometric feature in a field of view corresponding to the physical location of pick-up of the order, comparing the first geometric feature with a second geometric feature associated with the expected item to determine if the detected item is located at the physical location of pick-up of the order, causing, in response to a determination that the detected item is located at the physical location of pick-up of the order, a user interface corresponding to the physical location of pick-up of the order to present an indication of completion of the order or a portion of the order corresponding to the expected item.

For example, the method can include causing, in response to a determination that the detected item is not located at the physical location of pick-up of the order, the user interface corresponding to the physical location of pick-up of the order to present an indication of error in the order or a portion of the order corresponding to the expected item.

For example, monitoring can include linking, based on the item data, an expected item to a first field of view at a station among the stations corresponding to assembly of the expected item. The method can include detecting, by a first machine learning model receiving input corresponding to the first field of view, a first geometric feature in the first field of view, the first machine learning model trained with input can include a plurality of ingredients can include an expected ingredient linked with the expected item and corresponding to the ingredient data.

For example, executing can include causing, in response to a determination that the first geometric feature diverges from a second geometric feature corresponding to the expected ingredient, a user interface to present an indication of divergence.

For example, monitoring can include linking, in response to a determination that the first geometric feature matches a second geometric feature corresponding to the expected ingredient, the expected item to a second field of view for a second station among the stations corresponding to a location of transfer of the expected item.

For example, executing can include detecting a geometric code in the second field of view. The method can include causing, in response to a determination that the geometric code is within the second field of view, the user interface to present an indication of completion.

For example, monitoring can include detecting, by a second machine learning model receiving input corresponding to the second field of view, a third geometric feature in the second field of view, the second machine learning model trained with input can include a plurality of items can include the expected item.

For example, executing can include causing, in response to a determination that the third geometric feature diverges from a fourth geometric feature corresponding to the expected item, a user interface to present an indication of divergence.

For example, executing can include causing, in response to a determination that the third geometric feature matches the fourth geometric feature, the user interface to present an indication of completion corresponding to the expected item.

For example, method can include causing, in response to a determination that the first geometric feature matches a second geometric feature corresponding to the expected ingredient, the user interface to present an indication of completion corresponding to the expected ingredient.

For example, method can include linking, in response to a determination that the first geometric feature matches a second geometric feature corresponding to the expected ingredient, the expected item to a second field of view in the physical space corresponding to a location of transfer of the expected item. The method can include detecting, by a second machine learning model receiving input corresponding to the second field of view, a third geometric feature in the second field of view, the second machine learning model trained with input can include a plurality of items can include the expected item. The method can include causing, in response to a determination that the third geometric feature diverges from a fourth geometric feature corresponding to the expected item, a user interface to present an indication of divergence.

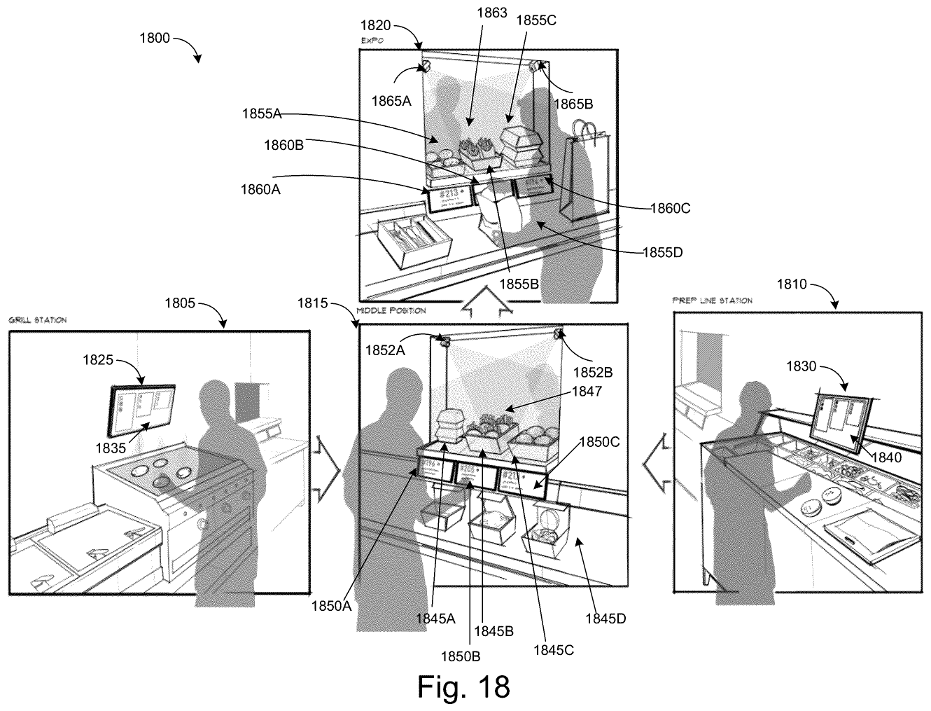

FIG. 18 depicts an example of order monitoring and verification process 1800, in accordance with some embodiments. The process 1800 includes a first station 1805, a second station 1810, a third station 1815, and a fourth station 1820. In some embodiments, the first station 1805 and the second station 1810 can be food preparation stations described above. Although only two food preparation stations are shown in FIG. 18, in other embodiments, greater than or fewer than two food preparation stations can be used in the process 1800. The third station 1815 can be an item assembly station that receives and assembles items for an order from various food preparation stations or other locations (e.g., in a restaurant). Although a single item assembly station (e.g., the third station 1815) is shown herein, in other embodiments, greater than one item assembly station can be used in the process 1800. In some embodiments, the fourth station 1820 can be an order assembly station that receives the assembled items from the third station 1815 to allow assembly of the order for pick-up by a customer. Although a single order assembly station (e.g., the fourth station 1820) is shown herein, in other embodiments, greater than one order assembly stations can be provided.

Each of the first station 1805 and the second station 1810 can have a user interface 1825 and 1830, respectively, associated therewith. The user interfaces 1825 and 1830 can correspond to the user interfaces described above (e.g., the user interfaces 260, 262) and can be configured to display one or more order tickets 1835 and 1840, respectively, associated with one or more orders being prepared at those stations. In some embodiments, the tickets 1835 and 1840 may only show portions of one or more orders that the respective one of the first station 1805 and the second station 1810 are to handle. For example, the first station 1805 can be a grilling station and the tickets 1835 on the display 1825 may only show the patties that the first station has to grill for one or more orders. Although not shown in FIG. 18, in some embodiments, prepared item from one station can be moved to another station for the next step of order preparation. For example, in some embodiments, the grilled patty from the first station 1805 can be sent to the second station 1810 for assembling into a burger.

Further, although not shown, each of the first station 1805 and the second station 1810 can be associated with one or more sensors (e.g., cameras) as described above to monitor the preparation of the food and update the tickets 1835 and 1840, respectively, accordingly. For example, in some embodiments, the machine learning model associated with the first station 1805 can receive data from the one or more sensors associated with the first station. Based on the sensor data from the one or more sensors, the machine learning model can match the item on the ticket with the item determined from the sensor data. For example, the machine learning model can determine that the ticket 1835 includes an order with a veggie patty. If the machine learning model detects a veggie patty from the sensor data received from the one or more sensors associated with the first station 1805, the machine learning model can update the ticket (e.g., by displaying a notification such as a green check mark or other indicia indicating successful completion). The machine learning model can identify the item (e.g., veggie patty) based on geometric features (e.g., shape, size), texture, color, composition, a combination thereof, or in any other way. If the ticket includes an order with two veggie patties, the machine learning model can update the quantity of the veggie patties on the ticket when a veggie patty is detected from the sensor data. Thus, the food preparation stations can be configured to prepare individual items of an order.

The third station 1815 can receive items from the food preparation stations and assemble the items. For example, in some embodiments, the third station 1815 can include preset zones and each zone can be associated with a user display. For example, FIG. 18 shows three zones 1845A-1845C on the third station 1815, each zone associated with a user display 1850A-1850C, respectively. In some embodiments, the three zones 1845A-1845C may be defined in a pass-through area 1847 of the third station 1815. In some embodiments, a fourth zone 1845D may be provided on a work surface or table of the third station 1815. Although three zones in the pass-through area 1847 and one zone on the work surface are shown in FIG. 18 on the third station 1815, in other embodiments, the third station can include greater than or fewer than three zones in the pass-through area and greater than a single zone on the work surface. In some embodiments, each zone can have a physical or virtual barrier delineating one zone from another. Each zone can be associated with one order. The user interfaces 1850A-1850C of each of the zones 1845A-1845C, respectively, can track the order assembly. In some embodiments, the fourth zone 1845D can also be associated with a user interface.

One or more of the zones 1845A-1845D can be dynamic zones. In other words, the designation of the zones to one or more orders can vary from order to order. In some embodiments, the fourth zone 1845D may be associated with multiple orders. When an item is assembled (e.g., burger placed in a container) in the fourth zone 1845D, the assembled item can be placed in one of the three zones 1845A-1845C associated with the respective order. Each of the zones 1845A-1845C may be designated to an order at the time the order is received.

Further, one or more sensors 1852A and 1852B can be associated with the third station 1815 to monitor the third station. In some embodiments, each of the zones 1845A-1845D can be associated with its independent one or more sensors to track the item in that zone. In some embodiments, each of the user interfaces 1850A-1850C can include a list of all items (whether food items, drink or beverage items, sauce or condiments packets, silverware, etc.) that are to be included in an order, including a quantity of each item in the order. In some embodiments, the user interfaces 1850A-1850C can display other or additional suitable information. The one or more sensors associated with each of the zones 1845A-1845D can track which items are being assembled. For example, if an order includes three burgers, the third station 1815 can receive three prepared burgers from the second station 1810. At the third station 1815, each of the three burgers can be put into an individual container. Each burger can be assembled in one of the zones 1845A-1845D.

For example, in some embodiments, the each burger can be assembled in the fourth zone 1845D. When the burger is assembled (e.g., the burger is put into a container), the container can be placed in one of the zones 1845A-1845C designated to the order associated with the burger. As the machine learning model associated with the third station 1815 receives sensor data from the one or more sensors associated with a zone of the third station, the machine learning model can determine if the assembled item is assembled properly (e.g., the assembly matches predetermined criteria such as whether the item was placed in a proper container, etc.) and whether the assembled item is intended to be part of the order shown on the user interfaces 1850A-1850C. In some embodiments, the machine learning model can also determine if the assembled item is placed in the right one of the zones 1845A-1845C. For example, if the assembled item is a burger associated with Order A, the machine learning model can determine whether the burger was placed in the zone of the zones 1845A-1845C assigned to Order A. In some embodiments, the machine learning model can determine whether the assembled item was placed in the correct zone based on a printed code on the assembled item. For example, in some embodiments, as discussed above, each order can be assigned a code (e.g., order number). One of the zones 1845A-1845D can be assigned to that code. The assembled item may also have the code. If the assembled item is placed in a zone such that the code on the assembled item does not match the code assigned to that zone, the machine learning model can determine that the assembled item is placed in the wrong zone. The machine learning model can determine that the assembled item is placed in the correct zone in other ways. In response to determining a match, the user interfaces 1850A-1850C can provide a notification of successful completion (e.g., visual indicator such as a green check mark, green LED, auditory response such as a ping, etc.).

The items assembled at the third station 1815 can be passed on the fourth station 1820 for order assembly Similar to the third station, the fourth station 1820 can be divided into dynamic zones, with each zone having an associated user interface to track and monitor the assembly in that zone. For example, the fourth station can include three preset zones 1855A-1855C in a pass-through area 1863 and each zone can be associated with a user interface 1860A-1860C, respectively. In some embodiments, a fourth zone 1855D may be provided on a work surface of the fourth station 1820. Although three zones are shown in FIG. 18 in the pass-through area 1863 and a single zone on the work surface of the fourth station 1820, in other embodiments, the fourth station can include greater than or fewer than three zones in the pass-through area and greater than one zone in the work surface. In some embodiments, each zone can have a physical or virtual barrier delineating one zone from another. Each zone can be a physical location on the work surface 1905 and associated with an order. The user interfaces 1860A-1860C of each of the zones 1855A-1855C, respectively, can track the order assembly similar to the third station 1815. Specifically, one or more sensors 1865A and 1865B can be associated with the fourth station 1820 to monitor the fourth station.

In some embodiments, each of the zones 1855A-1855C can be associated with its independent one or more sensors 1865A, 1865B to track the item in that zone. In some embodiments, each of the user interfaces 1860A-1860C can include a list of all items (whether food items, drink or beverage items, sauce or condiments packets, silverware, etc.) that are to be included in an order, including a quantity of each item in the order. The one or more sensors associated with each of the zones 1855A-1855C can track which items are being placed in a bag for order assembly. Order assembly is described in more detail below.

All items associated with an order can be placed in the zone assigned to that order. In some embodiments, each order can be assigned a zone at the fourth station 1820 when the order is received from the customer. As items are received from the third station 1815, the items can be placed in the zone associated with that order. As the machine learning model associated with the fourth station 1820 receives sensor data from the one or more sensors associated with a zone of the fourth station, the machine learning model can determine if each item in an order is received, whether incorrect items are placed in the bag, what items are still missing, and any other information that can be needed to monitor the accuracy of order assembly and fulfillment. The user interfaces 1850A-1850C, 1860A-1860C can show order statuses such as an order fulfilled but not bagged, order fulfilled, wrong item bagged, etc. “Bagging,” “bagged,” or like terms as used herein can include placing of all items of an order in the assigned zone. Order assembly tracking, dynamic zone assignment, and other aspects related with the fourth station 1820 are similar to those described above with respect to the third station 1815.

In some embodiments, a single station can be configured for both item assembly and order assembly. In such embodiments, the third station 1815 and the fourth station 1820 can be the same station (in other words, the process 1800 can include three stations). As assembled items are placed in the assigned zones, the machine learning model can track the items and the order, and the user interfaces can indicate when the orders are complete. After an order is complete and has been picked up, the zone associated with the picked up order can be assigned to a new order.

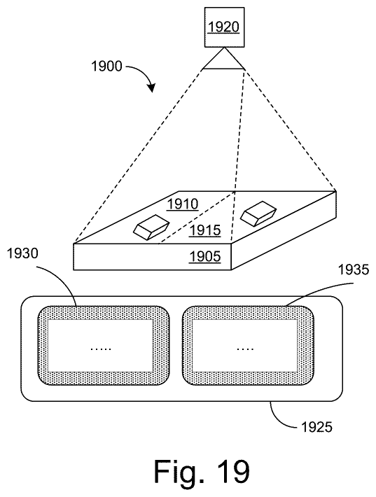

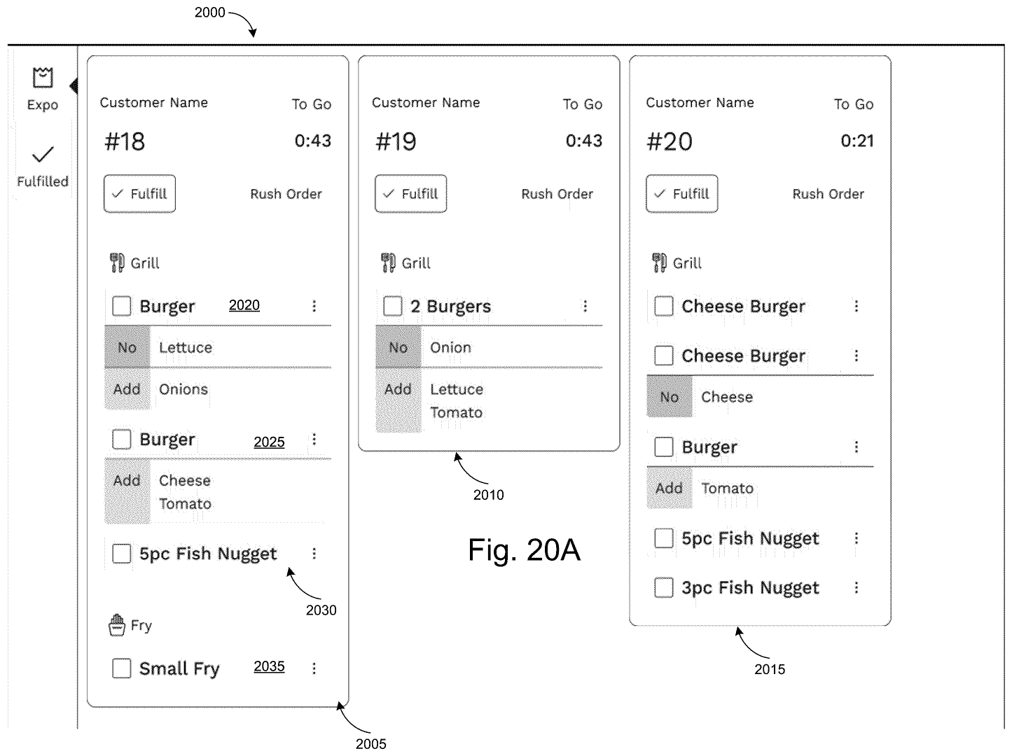

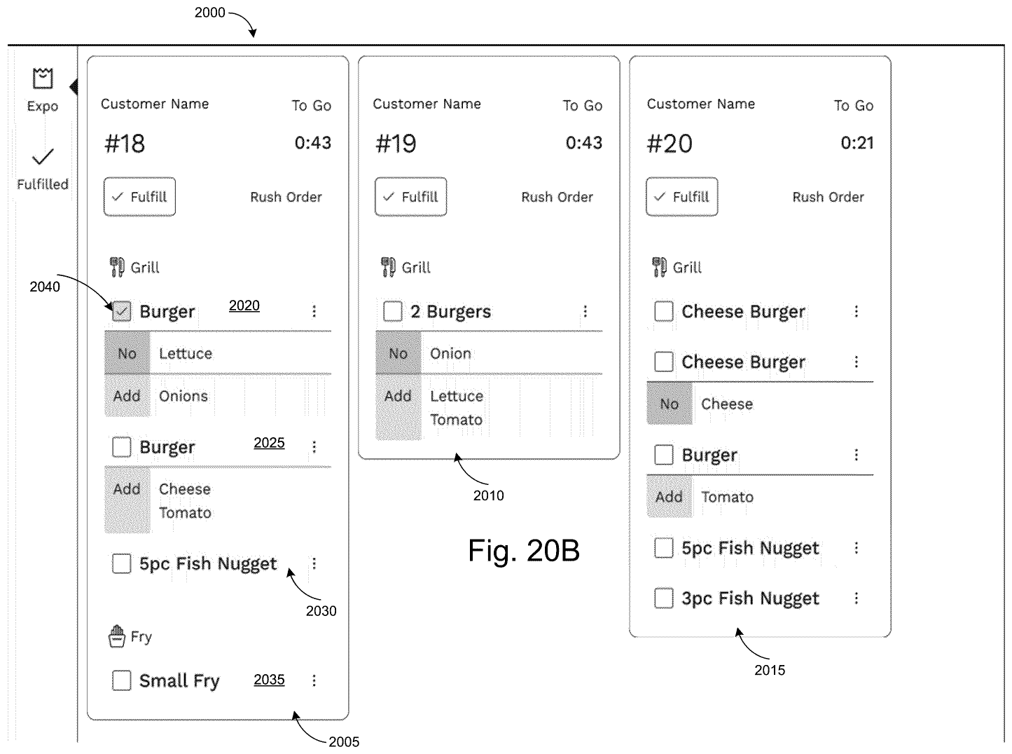

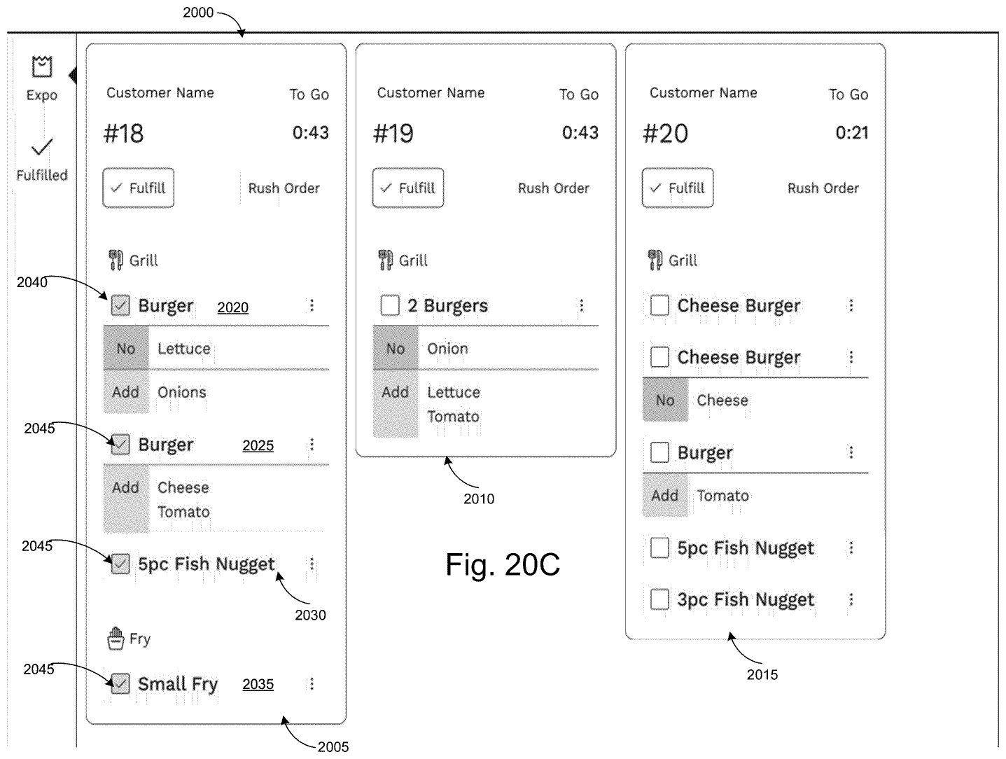

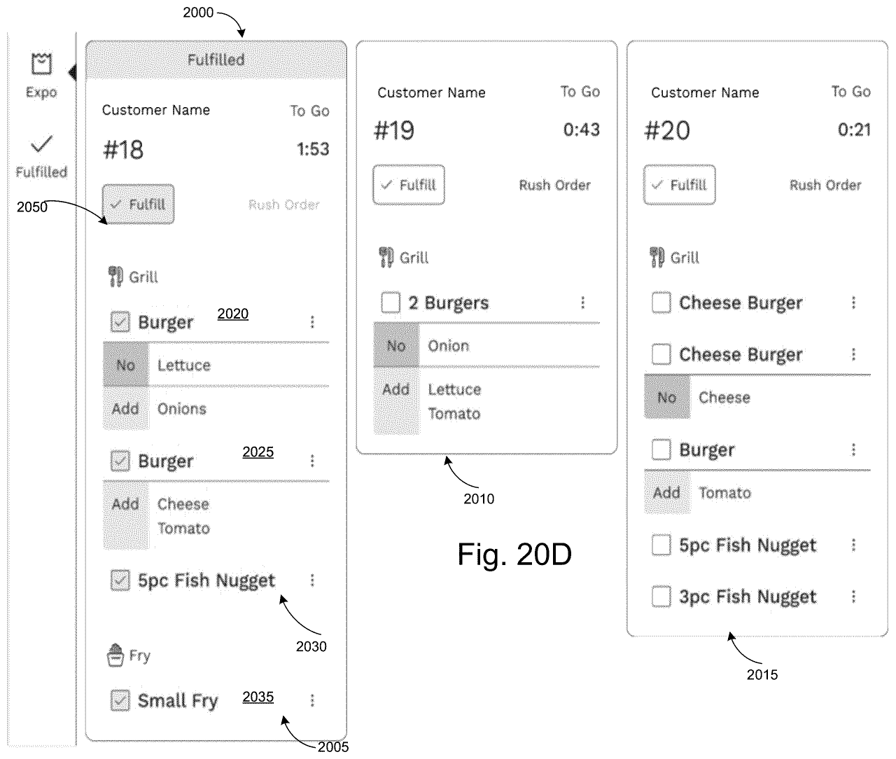

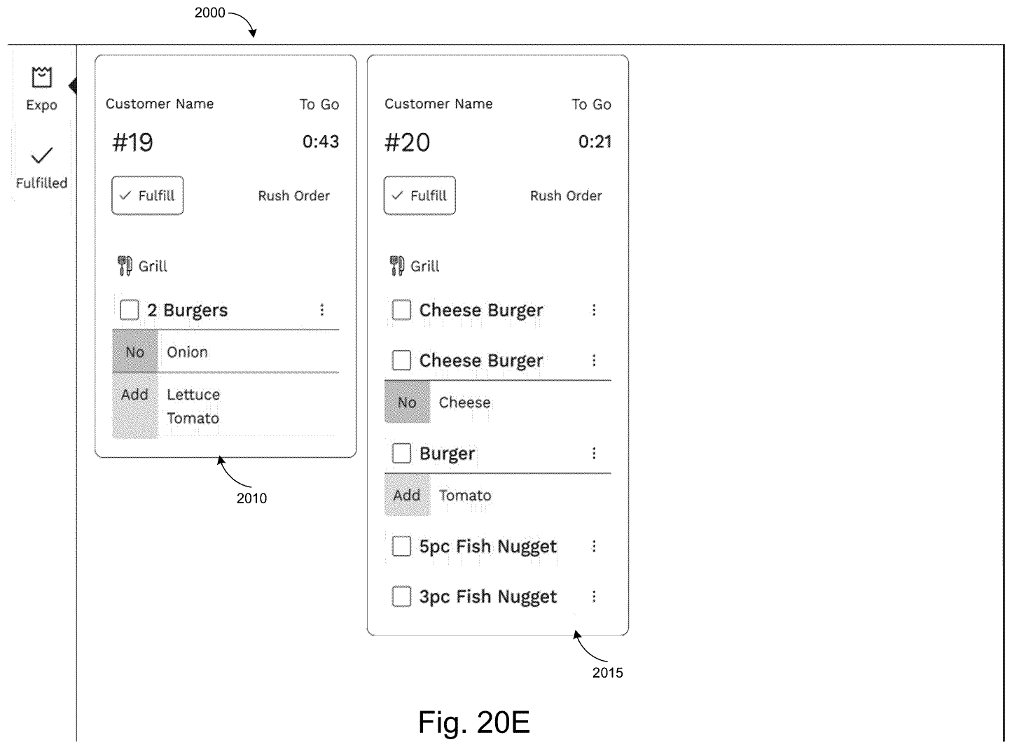

FIG. 19 depicts an example order assembly station 1900 and FIGS. 20A-20E depict example user interfaces for the order assembly station, in accordance with some implementations. The order assembly station 1900 can include a work surface 1905 divided into one or more preset zones, such as a first zone 1910 and a second zone 1915. Although two zones are shown, in other embodiments, the order assembly station 1900 can include a single zone or more than two zones. Each of the first zone 1910 and 1915 can be associated with an order. For example, in some embodiments, the first zone 1910 can be associated with a first order and the second zone can be associated with a second order. In some embodiments, the first zone 1910 can be associated with a first portion of a first order and the second zone 1915 can be associated with a second portion of the first order. Each order can be assigned on or more zones of the order assembly station 1900 when the order is received. In some embodiments, each order can be associated with an order number and one or more zones of the order assembly station 1900 can be linked with that order number. In other embodiments, other ways of linking the order with one or more zones of the order assembly station 1900 can be used. Thus, based on the size and type of orders, the zones that are assigned to an order can be dynamically varied.

Further, the order assembly station 1900 includes a sensor 1920 defining a field of view 1910. In some embodiments, the first zone 1910 can have a first sensor defining a first field of view for first zone and the second zone 1915 can have a second sensor defining a second field of view for the second zone. In other embodiments, and as shown, a single sensor can monitor all zones of the order assembly station 1900. Additionally, the order assembly station 1900 can be associated with a user interface 1925 with the user interface having a user interface portion for each zone. For example, the first zone 1910 can be associated with a first user interface portion 1930 and the second zone 1915 can be associated with a second user interface portion 1935. In other embodiments, each zone can have a separate user interface. Examples of user interfaces are shown in FIGS. 20A-20E below. The user interface 1925 can track and monitor the order assembly process.

For example, FIGS. 20A-20E show a user interface 2000 corresponding to the user interface 1925. The user interface 2000 shows three tickets 2005-2015, each ticket being associated with one zone of the order assembly station 1900 (assuming the order assembly station has three zones). FIGS. 20A-20E show how order assembly can be tracked and accuracy verified for the order 2005. However, a similar process can be followed, in parallel, for the orders 2010 and 2015. The order 2005 includes a list of items and their associated selected options to be included in the order. For example, the order 2005 includes a first burger 2020, a second burger 2025, fish nuggets 2030, and fries 2035. The machine learning model associated with the order assembly station 1900 can track the order 2005 as the order is assembled to ensure accuracy and completeness.

In some embodiments, the first burger 2020, the second burger 2025, the fish nuggets 2030, and the fries 2035 can be prepared at the first station 1805 and the second station 1810 described above in FIG. 18 and assembled (e.g., put into individual boxes) at the third station 1815 described above in FIG. 18 before being received at the fourth station 1820 (corresponding to the order assembly station 1900). When the machine learning model associated with the order assembly station 1900 identifies the first burger 2020 in the first zone of the order assembly station, the machine learning model can automatically, without user intervention, check a box 2040 against the first burger, as shown in FIG. 20B Likewise, as the machine learning model receives more items for the order 2005 in the assigned zone of the order assembly station 1900, the machine learning model associated with the order assembly station identifies those items and automatically, without user intervention, checks box 2045 against those items, as shown in FIG. 20C. In response to determining that all items in the order 2005 have been received, the machine learning model associated with the order assembly station 1900 checks a box 2050 indicating that the order 2005 has been fulfilled, as shown in FIG. 20D, and removes the order from the user interface 2000, as shown in FIG. 20E.

Having now described some illustrative embodiments, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one embodiment are not intended to be excluded from a similar role in other embodiments.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such embodiment decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mate-able and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

Scope of the systems and methods described herein is thus indicated by the appended claims, rather than the foregoing description. The scope of the claims includes equivalents to the meaning and scope of the appended claims.

What is claimed is:

1. A method comprising:
receiving an order for food, the order comprising order data;
identifying ingredient data and item data from the order data;
displaying at least one of a portion of the ingredient data or a portion of the item data on one or more stations configured for preparing the order, wherein the portion of the ingredient data and the portion of the item data displayed on each of the one or more stations is based on a task to be performed at a respective one of the one or more stations;
monitoring the task at each of the one or more stations as the task is performed for compliance with the portion of the ingredient data and the portion of the item data displayed at the respective one of the one or more stations; and
executing an action based on the monitoring.

2. The method of claim 1, wherein the monitoring further comprises:
linking, based on the portion of the item data displayed at a first station of the one or more stations, an expected item to a first field of view at the first station;
receiving, by a first machine learning model, sensor data detected from the first field of view;
determining, based on the sensor data, a first geometric feature associated with a detected item in the first field of view; and
comparing the first geometric feature with a second geometric feature associated with the expected item to determine if the detected item is the expected item indicated in the portion of the item data.

3. The method of claim 2, wherein the action further comprises:
causing, in response to determining that the first geometric feature diverges from the second geometric feature, a user interface to present an indication of divergence.

4. The method of claim 2, wherein the action further comprises:
linking, in response to determining that the first geometric feature matches the second geometric feature, the expected item to a second field of view of a second station of the one or more stations, the second station receiving the expected item from the first station.

5. The method of claim 4, further comprising:
detecting a geometric code in the second field of view, the geometric code associated with the detected item; and
causing, in response to determining that the geometric code is within the second field of view, the user interface to present an indication of completion corresponding to the expected item.

6. The method of claim 1, further comprising:
determining, based on the item data, a recipe for each item identified from the item data; and
determining, based on the recipe, the ingredient data comprising one or more ingredients used in the recipe.

7. The method of claim 6, further comprising:
determining, based on the ingredient data, a location for each of the one or more ingredients; and
presenting the location of each of the one or more ingredients on a user interface.

8. The method of claim 1, wherein the one or more stations comprises an order assembly station, and wherein the method further comprises:
designating one or more zones of the order assembly station to the order;
detecting, based on sensor data, one or more items in the one or more zones;
comparing each of the one or more items in the one or more zones with one or more expected items in the order; and
causing, in response to a determination that the each of the one or more items match the one or more expected items in the order, displaying of an indication of completion on a user interface.

9. The method of claim 8, further comprising:
causing, in response to a determination that at least one of the one or more items does not match any of the one or more expected items, the user interface to present an indication of error.

10. A system comprising:
a memory having computer-readable instructions stored thereon; and
one or more processors that execute the computer-readable instructions to:
receive an order for food, the order comprising order data;
identify ingredient data and item data from the order data;
display at least one of a portion of the ingredient data or a portion of the item data on one or more stations configured for preparing the order, wherein the portion of the ingredient data and the portion of the item data displayed on each of the one or more stations is based on a task to be performed at a respective one of the one or more stations;
monitor the task at each of the one or more stations as the task is performed for compliance with the portion of the ingredient data and the portion of the item data displayed at the respective one of the one or more stations; and
execute an action based on the monitoring.

11. The system of claim 10, the one or more processors further to:
link, based on the portion of the item data displayed at a first station of the one or more stations, an expected item to a first field of view at the first station;
receive, by a first machine learning model, sensor data detected from the first field of view;
determine, based on the sensor data, a first geometric feature associated with a detected item in the first field of view; and
compare the first geometric feature with a second geometric feature associated with the expected item to determine if the detected item is the expected item indicated in the portion of the item data.

12. The system of claim 11, the one or more processors further to:
cause, in response to a determination that the first geometric feature diverges from a second geometric feature corresponding to the expected ingredient, a user interface to present an indication of divergence.

13. The system of claim 11, the one or more processors further to:
link, in response to a determination that the first geometric feature matches the second geometric feature, the expected item to a second field of view of a second station of the one or more stations the second station receiving the expected item from the first station.

14. The system of claim 13, the one or more processors further to:
detect a geometric code in the second field of view, the geometric code associated with the detected item; and
cause, in response to a determination that the geometric code is within the second field of view, the user interface to present an indication of completion corresponding to the expected item.

15. The system of claim 10, the one or more processors further to:
determine, based on the item data, a recipe for each item identified from the item data; and
determine, based on the recipe, the ingredient data comprising one or more ingredients used in the recipe.

16. The system of claim 10, the one or more processors further to:
determine, based on the ingredient data, a location for each of the one or more ingredients; and
present the location of each of the one or more ingredients on a user interface.

17. The system of claim 10, the one or more processors further to:
designate one or more zones of the order assembly station to the order;
detect, based on sensor data, one or more items in the one or more zones;
compare each of the one or more items in the one or more zones with one or more expected items in the order; and
cause, in response to a determination that the each of the one or more items match the one or more expected items in the order, display of an indication of completion on a user interface.

18. The system of claim 17, the one or more processors further to:
cause, in response to a determination that at least one of the one or more items does not match any of the one or more expected items, the user interface to present an indication of error.

19. A non-transitory computer readable medium comprising computer-readable instructions stored thereon that when executed by one or more processors cause the one or more processors to:
receive an order for food, the order comprising order data;
identify, ingredient data and item data from the order data;
display at least one of a portion of the ingredient data or a portion of the item data on one or more stations configured for preparing the order, wherein the portion of the ingredient data and the portion of the item data displayed on each of the one or more stations is based on a task to be performed at a respective one of the one or more stations;
monitor the task at each of the one or more stations as the task is performed for compliance with the portion of the ingredient data and the portion of the item data displayed at the respective one of the one or more stations; and
execute an action based on the monitoring.

20. The computer readable medium of claim 19, wherein the one or more processors further executes computer readable instructions to:
link based on the portion of the item data displayed a first station of the one or more stations, an expected item to a first field of view at the first station;
receive via a first machine learning model, sensor data detected from the first field of view;
determine based on the sensor data, a first geometric feature associated with a detected item in the first field of view; and
compare the first geometric feature with a second geometric feature associated with the expected item to determine if the detected item is the expected item indicated in the portion of the item data.
